(19) United States
(12) Patent Application Publication
(10) Pub. No.: US 2022/0010041 A1
(43) Pub. Date: Jan. 13, 2022

(54) PHOTOCURABLE COMPOSITION AND METHODS AND SYSTEMS OF PREPARING AND CURING THE PHOTOCURABLE COMPOSITION

(71) Applicant: Phoseon Technology, Inc., Hillsboro, OR (US)

(72) Inventors: Theresa Thompson, West Linn, OR (US); Scott Igl, Portland, OR (US)

(21) Appl. No.: 16/926,472

(22) Filed: Jul. 10, 2020

(51) Int. Cl. C08F 22/20

(52) U.S. Cl. CPC C08F 22/20

(57) ABSTRACT

A photocurable composition and systems and methods of preparing and curing the photocurable composition are provided. In one example, a photocurable composition includes a photoinitiator mixture, consisting only of a mixture of biocompatible compounds, including one or more of naproxen, caffeine, uracil, quercetin, and cyanocobalamin, and a polymer resin.

### BACKGROUND AND SUMMARY

The vast majority of manufactured foodstuffs are sold in packaging printed with photocurable inks. Photocurable compositions have also found broad application in 3D printing of objects due to inherent advantages such as speed, lower temperature curing, and absence of solvents, as compared to other printing methods. Recently, food safety concerns related to migration of photoinitiators from food contact materials (FCM's) into the food products themselves, has increased. Similar concerns exist related to the toxicity and migration of photoinitiators in photocurable 3D-printing of biomedical implants. As such, industry standards for photocurable compositions utilized for food and pharmaceutical products and packaging and in the biomedical industries, are becoming increasingly stringent in order to mitigate migration of toxic photoinitiators. For example, recent regulations governing migration levels of substances from FCM's include EuPIA regulation (November 2016), Nestle list (Version 4.0.1, 2016), Swiss Ordinance (Annex 10, RS817.023.12), and EU No 10/2011 (latest consolidated version 02011R0010-EN-29.08.2019-014.001-2). Increasing molecular size of photoinitiators by forming olgomeric and/or polymeric analogs of conventional photoinitators can aid in reducing their migration rates. Furthermore, photocurable compositions using self-initiating polymer resins can obviate any risk of photoinitiator migration.

The inventors herein have recognized potential issues with the above approaches. Namely, oligomeric and polymeric analogs of conventional photoinitiators can significantly increase viscosity of the photocurable composition, which can constrain formulation flexibility. In the case of photocurable inks, increased viscosity can clog printer nozzles and reduce printing precision, reliability, and quality. Components such as polymer resins with lower monomer functionality may be incorporated into a photocurable composition to reduce viscosity; however, curing efficiency can be lowered, which can cause increased migration levels of other toxic compounds such as monomer and the like. Furthermore, byproducts of the photoinitiation can include fragments of the original photoinitiator molecule; these smaller mobile fragments can exhibit increased migration level risks. Further still, self-initiating resins are lower efficiency processes, and can thus slow product manufacturing and increase costs relative to conventional photocurable inks.

One approach that at least partially addresses the above issues includes a photocurable composition, including a photoinitiator mixture, consisting only of a mixture of biocompatible compounds, wherein the mixture of biocompatible compounds consists of FDA generally recognized as safe (GRAS) substances and FDA over-the-counter (OTC) compounds, including one or more of naproxen, caffeine, uracil, quercetin, and cyanocobalamin, and a polymer resin.

In this manner, the technical result of reducing migration levels of non-biocompatible substances, including toxic photoinitiator residues and byproducts, from photocured compositions can be achieved, while maintaining photocuring efficiency and manufacturing costs relative to conventional photocuring processes. In particular, by excluding non-biocompatible compounds from the photocurable initiator composition, migration levels of non-biocompatible photoinitiators can be precluded. Furthermore, compliance with ink migration levels and other industry standards and safety regulations can be achieved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIGS. 1-14 are data tables of curing test data for unpigmented photocurable compositions.

FIGS. 15-26 are data tables of curing test data for pigmented photocurable compositions.

FIG. 27 is a flow chart for an example method of preparing and curing a photocurable composition.

FIG. 28 is a schematic illustrating an example of a lighting system for photocuring a biocompatible composition.

FIG. 29 is a schematic illustrating components of a photocurable composition.

FIG. 30 shows plots of the irradiance and wavelength combinations for generation of curing test data reported in FIGS. 1-26.

### DETAILED DESCRIPTION

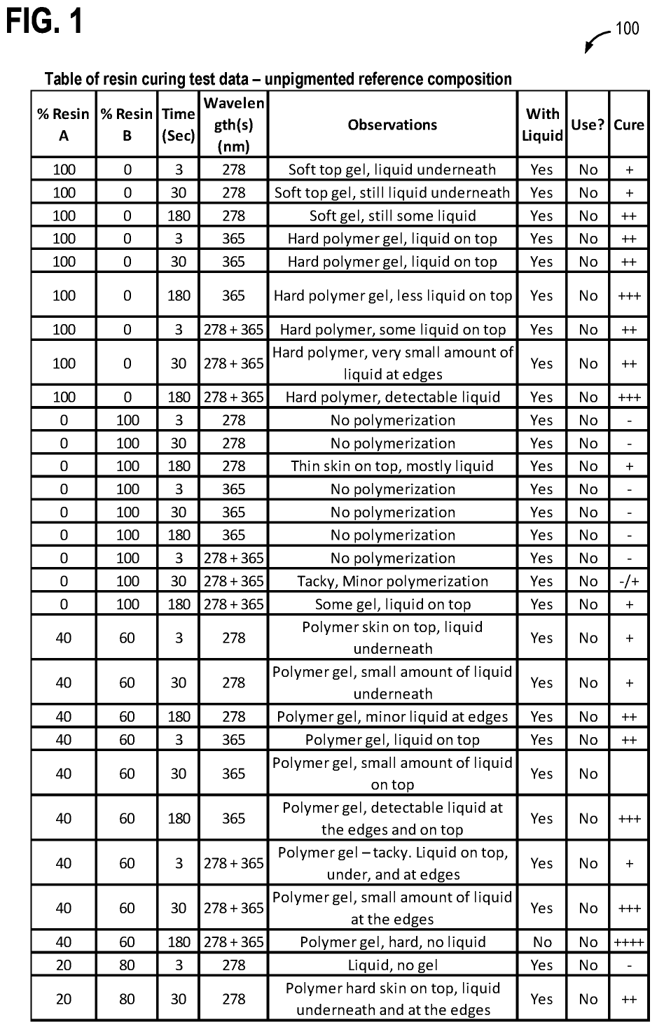

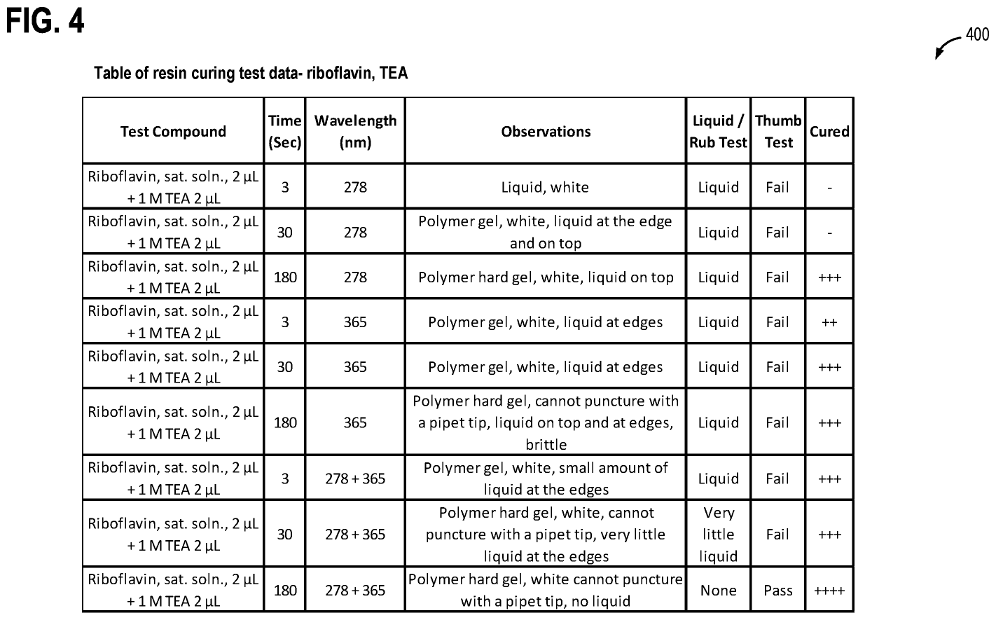

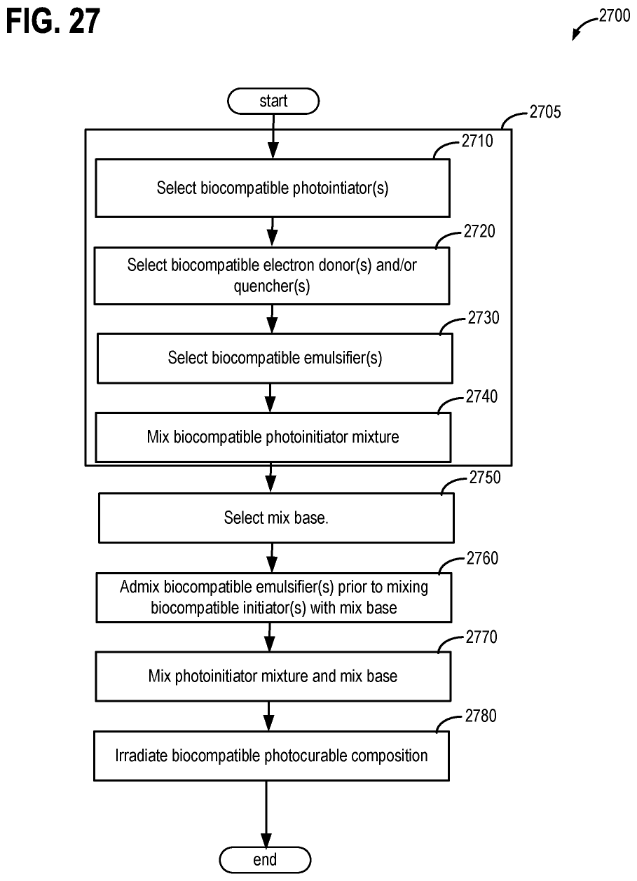

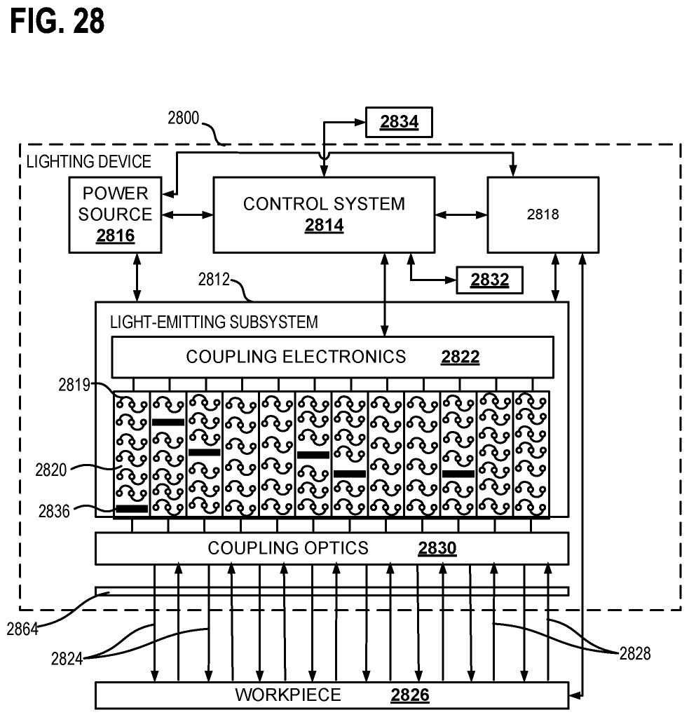

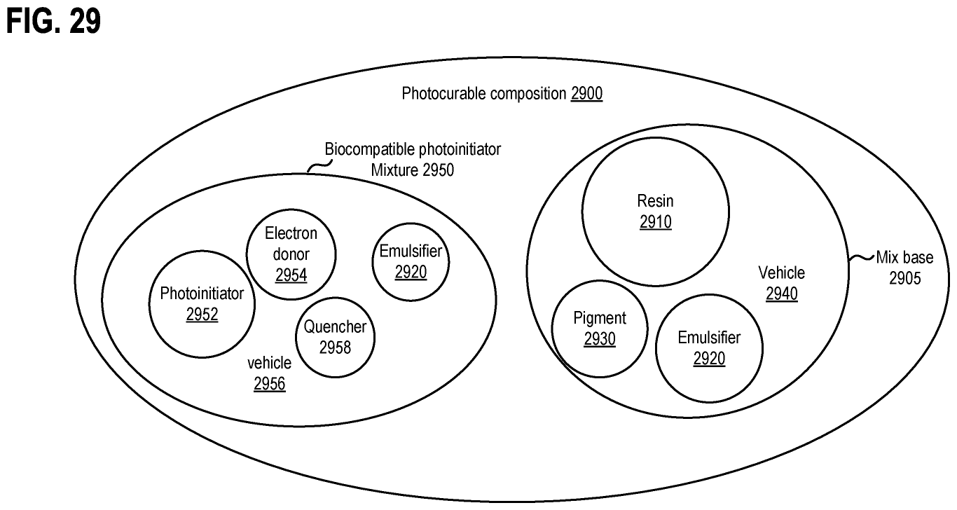

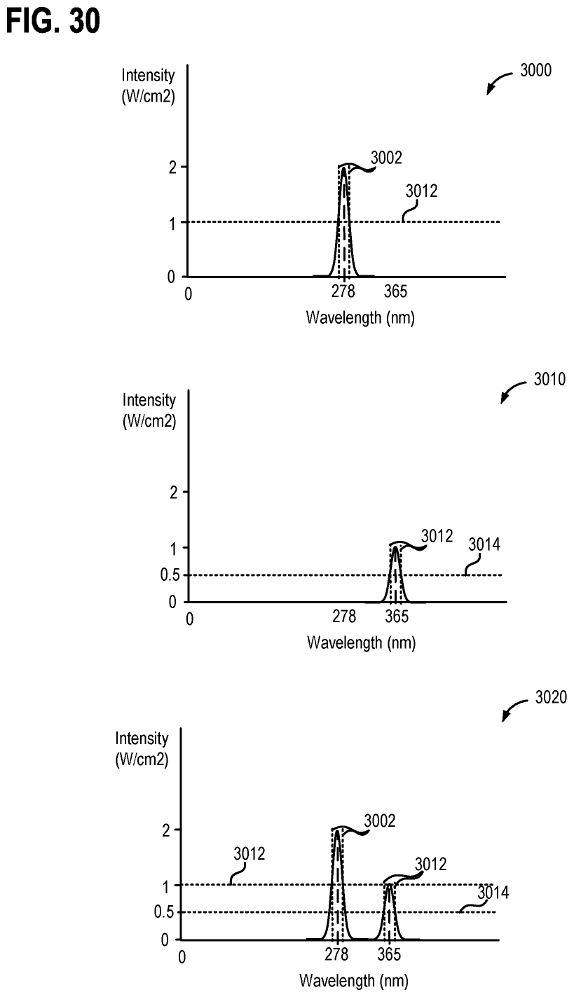

The present description relates to a photocurable composition as illustrated in FIG. 29, and methods and systems for preparing and curing the photocurable composition, which reduce a risk of toxic compounds migrating from the photocurable composition after curing while maintaining curing efficiency and manufacturing costs. FIGS. 1-26 are data tables showing curing test data for various unpigmented and pigmented photocurable compositions, including biocompatible photoinitiators. A method of preparing and curing a photocurable composition is illustrated in FIG. 27, and FIG. 28 shows an example lighting system for curing a photocurable composition, such as the photocurable composition of FIG. 29. The irradiance and wavelengths used for curing the photocurable composition are illustrated in FIG. 30.

A photoinitiator is a substance that generates reactive species, including free radicals, cations, or anions, upon exposure to radiation such as UV or visible light. The photoinitiator-generated reactive species can initiate polymerization of monomers and oligomers, and can be utilized for curing polymer resins. Conventional photoinitiators include benzophenone, thioxanthone, onium salt, nitrile, azo, benzylketal, benzoin, hydroxyacetophenone, phosphine oxide, and alpha-aminoalkylacetophenone, all of which are toxic and non-biocompatible. Conventional photocurable compositions, including non-biocompatible photoinitiators, exhibit increased risks for migration of the non-biocompatible photoinitiators from the photocured compositions. As described further below, photocurable compositions including photoinitiator mixtures consisting only of biocompatible compounds can reduce migration levels of toxic photoinitiators while maintaining photocuring efficiency. Herein, use of the term biocompatible refers to compounds that are deemed to be Generally Regarded As Safe (GRAS) by the Food and Drug Administration (FDA), substances FDA-approved for use in foods, or compounds that are available as active ingredients in FDA Over-The-Counter (OTC) formulations.

Turning now to FIG. 29, it shows a schematic illustrating the components of a photocurable composition 2900. Photocurable composition 2900 may include a mix base 2905, which may include one or more of resin 2910 and pigment 2930 borne in a vehicle 2940, emulsifier 2920; and a biocompatible photoinitiator mixture 2950, which may include one or more of photoinitiator (a single photoinitiator or combination of photoinitiators) 2952, electron donor 2954, quencher 2958, emulsifier 2920, and vehicle 2956. Biocompatible photoinitiator mixture 2950 consists only of biocompatible compounds, whereas the mix base 2905 may include non-biocompatible compounds and does not include biocompatible photoinitiators. Resin 2910 may include one or more polymer resins comprising solvent, diluent, and polymerizable monomer, oligomer, and crosslinker, without biocompatible photoinitiators. The polymerizable components of resin 2910 refer to compounds such as acrylates, esters, urethanes, and the like, that may undergo polymerization in the presence of photoinitiator-generated reactive species. In some examples, the polymerizable components of the resin 2910 includes acrylate resins. Example resins may include but are not limited to Sartomer CN1000 (Resin A), including acrylate oligomer, acrylate ester, and acrylic oligomer; and Sartomer CD564 (Resin B), including alkoxylated hexanediol diacrylate monomer. In some example resins 2910, the polymerizable monomer may act as a solvent and/or vehicle for the polymerizable oligomer and crosslinker in the absence of other solvent.

The pigment 2930 may include one or more pigments (e.g., solid pigments, colorants, dyes, and the like), dispersants, diluents, surfactants, and other components, without photoinitiator, commonly found in pigmented inks. One example of the pigment 2930 may include a pigmented ink base such as Miramer MNA857, a photocurable ink base. Resin 2910 and pigment 2930 may each be dispersed and/or at least partially solubilized in a vehicle 2940. As such, vehicle 2940 may include one or a combination of solvents and/or diluents. Non-limiting examples of vehicle 2940 include water, ethanol, and other solvents and/or diluents commonly found in inks, coatings, and the like.

Photocurable composition 2900 may include organic chemical mixtures and components such as resin 2910, pigment 2930 and/or vehicle 2940. In contrast, biocompatible photoinitiator mixture 2950 may include aqueous solutions of biocompatible compounds. As such, attaining homogeneously mixed solutions, suspensions, and/or dispersions of the photocurable compositions may be difficult as the organic (more nonpolar) compounds may not be miscible with the aqueous (more polar) compounds. To this end, photocurable composition 2900 may include a biocompatible emulsifier 2920 to aid in more compatibly mixing the biocompatible photoinitiator mixture 2950 with the vehicle-borne resin 2910 and pigment 2930 for increasing contact surface area therebetween, and thereby aiding in increasing photocuring efficiency. As suggested in FIG. 29 and described herein in further detail, the emulsifier 2920 consists only of a biocompatible emulsifier, and may be admixed to the photocurable composition 2900 components separate from the biocompatible photoinitiator mixture 2950, prior to being admixed with the biocompatible photoinitiator mixture 2950. The emulsifier 2920 does not include photoinitiator.

The biocompatible photoinitiator mixture 2950 consists of one or more of photoinitiator 2952, quencher 2958, and electron donor 2954 borne in vehicle 2956, and emulsifier 2920. Each of the photoinitiator 2952, electron donor 2954, quencher 2958, vehicle 2956, and emulsifier 2920 consist only of biocompatible compounds, as defined hereinabove, such that the biocompatible photoinitiator mixture 2950 consists only of biocompatible compounds. In other words, biocompatible photoinitiator mixture 2950 does not include benzophenone, thioxanthone, onium salt, nitrile, azo, benzylketal, benzoin, hydroxyacetophenone, phosphine oxide, and alpha-aminoalkylacetophenone. As examples, photoinitiator 2952 may include one or more biocompatible photoinitiators including, but not limited to vitamin compounds such as riboflavin (CAS #83-88-5) and cyanocobalamin (CAS #68-19-9); a salicylate including aspirin (CAS #50-78-2); an amino acid including L-Tryptophan (CAS #73-22-3); and other biocompatible compounds including naproxen (CAS #22204-53-1), caffeine (CAS #58-08-2), dihydrobiopterin (CAS #6779-87-9), eosin Y (CAS #17372-87-1), and uracil (CAS #66-22-8). In some examples, one or more of the photoinitiators 2952 may be admixed to the biocompatible photoinitiator mixture 2950 in powder form. In other examples, one or more of the photoinitiators 2952 may be solubilized and/or suspended in a biocompatible vehicle 2956 such as water and/or ethanol. Preferred liquid (aqueous and in alcohol where indicated) concentration ranges as well as powder density ranges of various biocompatible photoinitiators 2952 for incorporation into the biocompatible photoinitiator mixture 2950 are listed in Table 1.

The liquid photoinitiator solution (or suspension) is mixed with emulsifier and then the mixture is added to the ink composition. The concentration ranges described in Tables 1 and 2 indicate preferred concentration ranges. For the solutions referenced in Tables 1 and 2, higher concentrations of the biocompatible initiators in liquid solution more readily emulsified when mixed with the polymer and monomers of an ink composition. Furthermore, higher concentrations of photoinitator in solution with emulsifier mix more evenly with the ink resulting in a more uniform cure as assessed in our proofer curing assessments. Concentrations of photoinitiator may be limited by the solubility of the photoinitiator. Excessive water (or alcohol) in an ink composition may adversely affect curing. For example, an uneven texture or spattering may occur.

For addition of the powdered photointiators, the photointiator powder or the photointiator powder plus the emulsifier powder were premixed into a small volume of ink monomer or polymer (e.g., CN1000). Preferred concentrations of powdered photoinitiators and powdered initiators are below 10 wt. %. The mixture was then added to the ink base and mixed until evenly distributed. Mixing can be accomplished by multiple means including vortexing followed by centrifugation (to remove air bubbles from the suspension), sonication, inversion, stirring, or combinations of the above.

TABLE 1
Biocompatible photoinitiator use ranges

| | | | | | Cyano- |
|---|---|---|---|---|---|
| | Riboflavin | Naproxen | Caffeine | Uracil | cobalamin |
| Curing | 278 | 278 | 278 | 278 | 510 |
| wavelength | 365 | 365 | 365 | 365 | 558 |
| (nm) | | | | 405 | 698 |
| Aqueous | 0.05-10 | 10 μM- | 0.04-5 | 0.1-10 | 0.04-5 |
| conc.** | (mg/mL) | 25 mM | (mM) | (μM) | (mM) |
| | 20-800* | | | | |
| | (μM) | | | | |
| Powder | Add directly or | 50 μg/mL- | Add directly or | NT | NT |
| form | with emulsifier | 10 mg/mL | with emulsifier | | |
| | 0.05-10 | | 0.05-10 | | |
| | (mg/250 μL) | | (mg/250 μL) | | |

| | Aspirin | L-Tryptophan | Dihydrobiopterin | Eosin Y |
|---|---|---|---|---|
| Curing | 278 | 278 | 365 | 278 |
| wavelength | 365 | 365 | | 365 |
| (nm) | | | | |
| Aqueous | 0.04-10 | 0.04-5 | 1-80 | 0.04-5 |
| conc. | (mM) | (mM) | (μg/mL) | (mM) |
| Powder | Add directly or | Add directly or | NT | Add directly or |
| | with emulsifier | with emulsifier | | with emulsifier |
| | 0.05-10 | | | 0.05-10 |
| | (mg/250 μL) | | | (mg/250 μL) |

*Solution concentration in ethanol
**Aqueous concentrations are concentrations prior to addition of the photoinitiator mixture to the ink or ink base.
NT: Not Tested

Further to the preferred concentrations and conditions listed in Table 1, additional threshold levels associated with the biocompatible photoinitiators can be described. In the case of riboflavin, an upper threshold concentration is the saturated aqueous solution concentration of 12 mg/mL. In the case of caffeine, a 10 mM aqueous caffeine solution will become insoluble below a temperature of 4 degrees Celsius.

The biocompatible photinitiator mixture 2950 may include an emulsifier 2920. Similar to the biocompatible emulsifier 2920 previously described, the emulsifier 2920 may be admixed to the photoinitiator mixture 2950 to aid in attaining a homogeneously mixed photocurable composition. Furthermore, emulsifier 2920 and/or biocompatible emulsifier 2920 may aid in masking or protecting charged or water-soluble photoinitiators from oxygen, thereby reducing side reactions of photoinitiator-generated reactive species with oxygen, and facilitating a higher effective generation rate of photoinitiator-generated reactive species and more efficient photocuring. The emulsifier may be mixed directly into the organic components of the photocurable composition 2900; alternately or additionally, the emulsifier may be mixed with the photoinitiator mixture 2950 prior to admixing of the photoinitiator mixture 2950 with the remaining components of the photocurable composition 2900. As examples, the emulsifier 2920 and/or the biocompatible emulsifier 2920 may include one or more biocompatible emulsifiers such as sodium stearoyl lactylate (SSL) (CAS #25383-99-7), L-alpha-phosphatidyl choline (LPC) (CAS #8002-43-5), and/or 2-hydroxyethyl cellulose (2HEC) (CAS #9004-62-0). Conditions for admixing each of these emulsifiers is listed in Table 2. The emulsifiers may be admixed in solid powder form and/or as an aqueous suspension to the photocurable composition by sonication (VWR Symphony Model #97043-940) and/or vortexing (Scientific Instruments Vortex Genie 2 Model #SI-0236). In one example, the emulsifier was admixed to the photocurable composition while sonicating for 5 min at 37 degrees Celsius, and was repeated until homogeneous dispersion in the photocurable composition was obtained. Suspending the emulsifier as an aqueous suspension may facilitate incorporating higher emulsifier concentrations into the photocurable composition. In some examples, the biocompatible emulsifier 2920 may be admixed to the biocompatible photoinitiator mixture 2950 prior to mixing with the mix base 2905. In other examples, the biocompatible emulsifier 2929 may be admixed to the mix base 2905 prior to mixing the mix base 2905 with the biocompatible photoinitiator mixture 2950.

TABLE 2
Biocompatible emulsifiers

| | Sodium stearoyl | L-a-phosphatidyl | 2-hydroxyethyl |
|---|---|---|---|
| | lactate (SSL) | choline (LPC) | cellulose (2HEC) |
| Physical | Powder | Powder | Suspension |
| state | | | in water |
| | | | (10-100 μg/μL) |
| Method | Sonicate and/ | Sonicate and/ | Sonicate and/ |
| | or vortex | or vortex | or vortex |
| | SSL into | LPC into | 2(HEC) into |
| | photocurable | photocurable | photocurable |
| | composition | composition | composition |
| | to disperse | to disperse | to disperse |
| Use range | 0.1-8 | 0.25-6 | 20 μg/mL- |
| (mg powder/ | (mg/100 μL), | (mg/mL) | 10 mg/mL |
| volume | preferably | Most preferably | |
| mixture) | 1-6 (mg/μL), | 1 mg/0.1 mL | |
| | Most preferably | | |
| | 1 (mg/μL) | | |

The biocompatible photoinitiator mixture 2950 may include one or more electron donors 2954 and/or quenchers 2958 for aiding in increasing the photoinitiation kinetics. Examples of biocompatible electron donors 2954 and/or quenchers 2958 include L-arginine (CAS #74-79-3), triethanolamine (TEA) (CAS #102-71-6), triethanolamine-hydrochloride (TEA-HCl) (CAS #554-68-7), and quercetin (CAS #615-25-3). Conditions for admixing these electron donors and quenchers is listed in Table 3. The electron donor 2954 and/or quencher 2958 may be added directly to the biocompatible photoinitiator mixture 2950 or added with emulsifier 2920 to the biocompatible photoinitiator mixture 2950 to aid in increasing mixing compatibility.

TABLE 3
Biocompatible electron donors, quenchers

| | | Triethanolamine | | Quercetin |
|---|---|---|---|---|
| | L-Arginine | (TEA) | TEA-HC1 | (quencher) |
| Concentration | 0.43-40 mM | 99% solution | 0.4-200 mM | 0.01-198.5 μM |
| (mg/mL) | (aqueous) | diluted | (aqueous) | (aq.) |
| | | 1:500 to 1:10 | | Add 1:1 directly |
| | | in mixture | | or w/emulsifier |
| Powder | Powder add | N/A | Powder add | Powder add |
| (mg/L) | directly or | | directly or | directly or |
| | with emulsifier | | with emulsifier | with emulsifier |
| | | | | 0.01 to 198.5 μM |

N/A: TEA is a non-aqueous liquid

Photocuring was performed with various irradiation lighting devices as described by the lighting device 2800 of FIG. 28. Irradiation sources and conditions are listed in Table 4, including the irradiation wavelength and power, as well as the distance from the irradiation source to the irradiated target. In some examples, the irradiation device emitted single peak wavelength irradiation, while in other examples, multiple single peak wavelength irradiation was emitted. In cases where the target is irradiated with multiple single peak wavelength radiation, the multiple single peak wavelength irradiation may be independently controlled so that the multiple single peak wavelengths may be emitted from the irradiation source simultaneously and/or sequentially. Examples of single peak wavelength irradiation are shown in FIG. 30, where plot 3000 illustrates single peak wavelength irradiation at 278 nm with an intensity of 2 W/cm²; plot 3010 illustrates single peak wavelength irradiation at 365 nm with an intensity of 1 W/cm²; and plot 3020 illustrates multiple single peak wavelength irradiation at 278 nm with an intensity of 2 W/cm² simultaneously with irradiation at 365 nm with an intensity of 1 W/cm².

In particular, irradiation at a single peak wavelength, as referred to herein, includes irradiation with radiation having a narrow spectrum (Gaussian distribution) of wavelengths, with a single peak intensity at the single peak wavelength, a +/−5 to 7 nm FWHM (full width half max), less than 10% of peak wavelength intensity beyond +/−10 nm from the peak wavelength, and essentially without any irradiation intensity beyond +/−15 nm from the peak wavelength. In plots 3000, 3010, and 3020, for LED irradiation at single (and multiple single) peak wavelengths 278 nm and 365 nm, the FWHM wavelengths are indicated by 3002 and 3012, respectively; and the half maximum single peak intensities are indicated by 3004 and 3014, respectively.

TABLE 4
Irradiation sources

| | Single peak | Distance | |
|---|---|---|---|
| | wavelength* | from source | Power |
| Irradiation source | (nm) | (mm) | (W/cm2) |
| Phoseon 395 | 395 | 25 | 12 |
| Phoseon 278/365 | 278 | 25 | 2 |
| | 365 | 25 | 1 |
| Phoseon 420/440 | 420 | 25 | 5 |
| | 440 | 25 | 5 |
| Phoseon 365/385/405 | 365 | 25 | 5 |
| | 385 | 25 | 5 |
| | 405 | 25 | 5 |

*narrow Gaussian distribution with FWHM at +/− 5 nm from peak wavelength

Turning now to FIGS. 1-26, they illustrate data tables of curing test results for various photocurable compositions 2900, including several biocompatible photoinitiator mixtures 2950 and emulsifiers 2920, and not including non-biocompatible photoinitiators. FIGS. 1-14 correspond to curing tests for unpigmented photocuring compositions without emulsifier. Assessment of each photocurable composition was performed by curing tests, whereby liquid mixtures of either CN1000:CD564 resin mixtures and/or MNA857 ink base were mixed with test compounds (e.g., biocompatible photoinitiator mixture and/or emulsifier) as described in FIGS. 1-26, and irradiated with the specified intensity, wavelength of radiation, and duration. In particular 50 μL of the photocurable composition was mixed and dispensed on an aluminum foil substrate attached to a glass slide for ease of handling. In the case of ink base mixtures (e.g., photocurable compositions included biocompatible photoinitiator mixtures with cyan ink (MNA857)), approximately 200 μL of the ink base mixtures is applied to a Phantom Proofer (HarperScientific.com), whereby each ink base mixture is applied to a 4 inch×11 inch strip of white paper by rolling over the paper 3-4 times to deposit a dark ink layer thereon.

Each photocuring test was evaluated using several assessment methods: A visual assessment determines if the ink is still liquid, and not cured. If the ink is not cured, thumb twist and rub tests are not performed. Next, a thumb twist test is performed whereby the irradiated surface is touched with a thumb (nitrile gloved thumb), lightly pressed, while twisting. If ink is transferred to the thumb, then the irradiated surface is not cured. Next, a rub test is performed whereby the irradiated surface is rubbed with a swab (e.g., a pad for a mechanical rub test device such as a crock test); if the ink is transferred to the swab, the ink is not cured. Next, a liquid assessment is performed whereby a thin absorbent tissue is pressed to the irradiated surface and surrounding foil substrate, and the tissue is visually assessed for increased translucence resulting from liquid wetting thereof. Based on the results of the visual, thumb twists, and rub assessments, cure performance ratings are assigned to each photocurable composition test: ‘-’ denotes no curing and is equivalent to no exposure to irradiation; ‘+’ denotes some curing and the photocurable composition remains adhered to the substrate, but exhibits significant smearing after the rub test.

Printing examples (FIGS. 15-26) conducted with the Phantom Proofer included subjecting the photocurable compositions to irradiation of 1.3 s per inch at 365 nm and 278 nm wavelengths, while exposures to radiation at 395 nm were at 0.3 s per inch. Overall irradiation times were shorter than those for example curing tests that were not printed (FIGS. 1-14). All irradiation was conducted at a distance of 25 mm from the radiation source window to the target surface. For each print test, 10 μL of a photocurable composition was added to 100 μL of the ink (MNA857) and homogeneously mixed prior to loading into the proofer and printed. Curing of the printed examples demonstrate the functionality of the photocurable compositions in the presence of pigment quantities representative in a commercial ink.

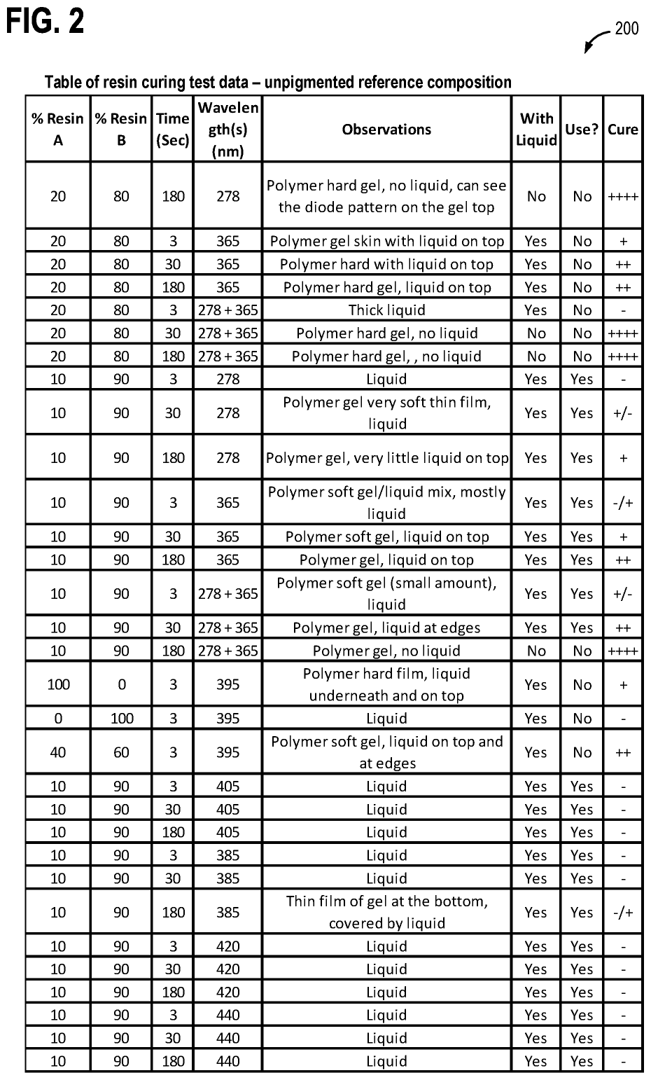

Turning now to FIGS. 1 and 2, they show data tables 100 and 200 for curing assessments of unpigmented photocurable compositions without emulsifier and without photoinitiator, including resin (indicated by % ratios of CN1000 and CD564), irradiation time, irradiation wavelength, curing extent observations, presence of liquid, curing assessment and recommendations to use as a potential biocompatible photocurable composition. The unpigmented photocurable compositions without emulsifier and without photoinitiator (and without electron donor and quencher) were assessed to determine a suitable unpigmented reference curing composition and conditions for subsequent photocurable compositions including photoinitiator and/or emulsifier and/or electron donor and/or quencher. From the tabulated data of FIGS. 1 and 2, the 10%:90% CN1000:CD564 resin composition was chosen for the unpigmented reference composition since it exhibited a lower extent of curing over each of the irradiation wavelength and duration conditions. A lower extent of curing for the unpigmented reference composition may be more sensitive for detecting changes in curing extent upon addition of additional components such as biocompatible photoinitiators, emulsifiers, and/or electron donors/quenchers. Furthermore, the 10%:90% CN1000:CD564 resin composition presented as a clear and colorless mixture both pre- and post-irradiation.

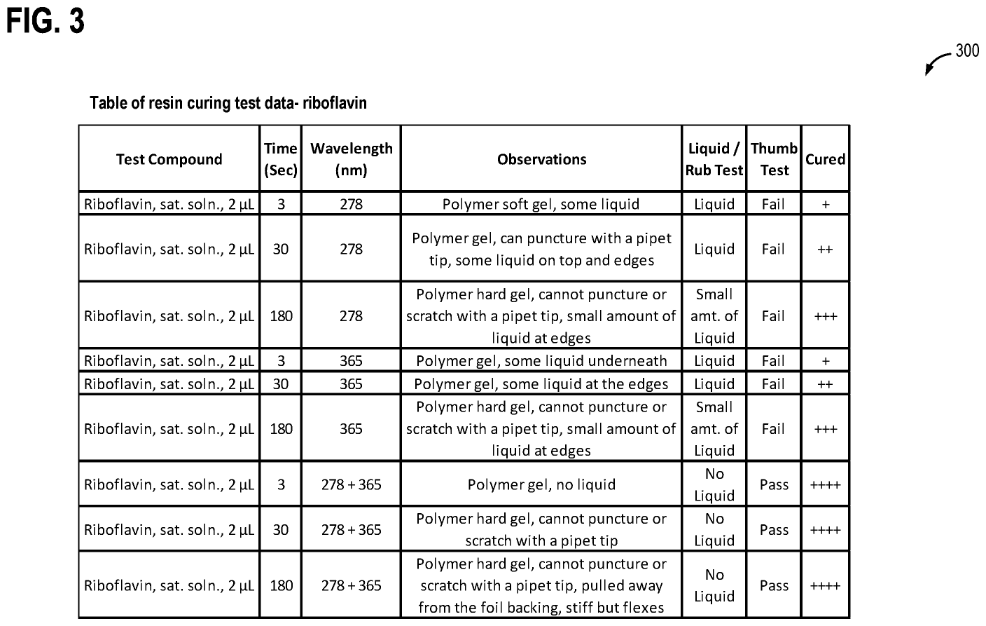

Referring to FIGS. 3-5, they illustrate data tables 300, 400, and 500 for curing tests for photocurable compositions including 2 μL saturated aqueous solution of a test compound (e.g., biocompatible photoinitiator mixture 2950) mixed with 50 μL of the 10%:90% CN1000:CD564 unpigmented reference composition (e.g., mix base 2905). Data tables 300, 400, and 500 correspond to a test compound including 2 μL of a saturated solution of riboflavin, 2 μL of a saturated solution of riboflavin with 2 μL 1M TEA, and 2 μL of a saturated solution of riboflavin with 2 μL 85.3 mM L-Arginine, respectively. Addition of riboflavin to the unpigmented reference composition increases curing extent when irradiated at single peak wavelength radiation at 278 nm, 365 nm, and with simulataneous multiple single peak wavelength radiation at 278+365 nm, as compared to the unpigmented reference composition alone. The addition of TEA exhibited increased curing extent only after 180 s exposure at 278 nm, while other wavelength conditions exhibited unchanged or only slightly increased curing extents relative to the unpigmented reference compositions with riboflavin. Addition of L-Arginine (along with riboflavin to the unpigmented reference composition) exhibited increased curing extents under each curing test condition, in particular with more complete curing achieved at shorter exposure times when irradiated at 278 nm+365 nm radiation.

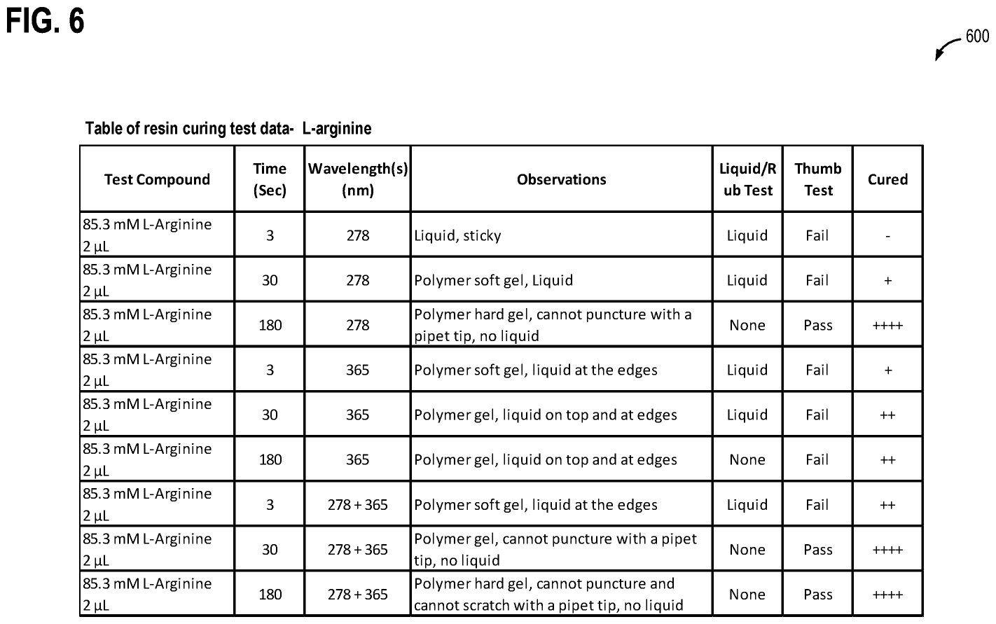

Turning now to FIG. 6, it illustrates a data table 600 for photocurable compositions including 2 μL of 85.3 M L-Arginine aqueous solution mixed with 50 μL of the 10%:90% CN1000:CD564 unpigmented reference composition. For curing conditions where the photocurable composition was irradiated with 365 nm radiation only, no increase in curing extent is observed relative to the unpigmented reference composition. When the photocurable composition was irradiated with 278 nm radiation, only the longer exposure duration of 180 s exhibited increased curing extent relative to the unpigmented reference composition. At combined 278+365 nm exposure, increased curing extents were observed after 3 and 30 s exposure times.

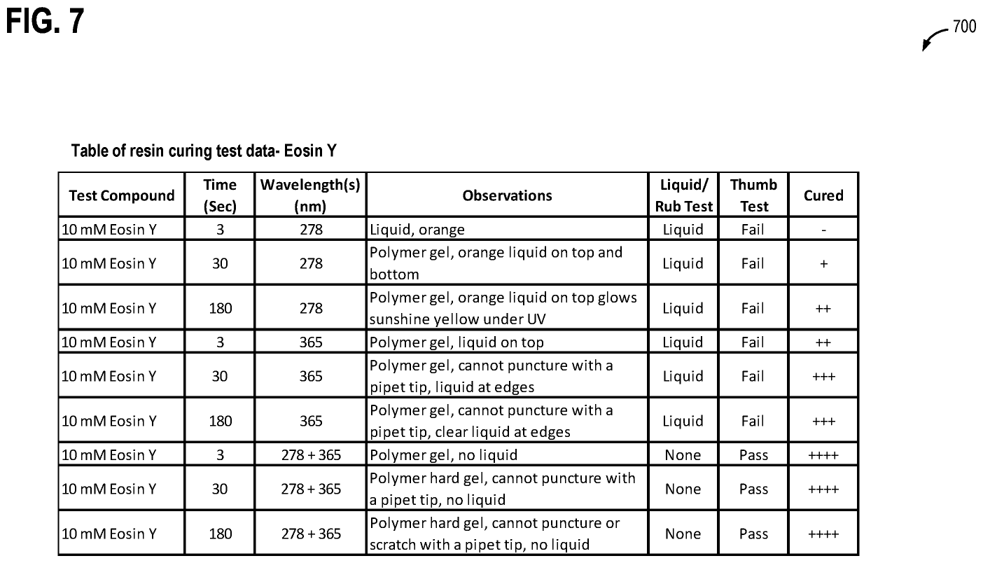

Turning now to FIG. 7, it illustrates a data table 700 for photocurable compositions including 10 mM Eosin Y aqueous solution mixed with 50 μL of the 10%:90% CN1000:CD564 unpigmented reference composition. When the photocurable composition was irradiated with 365 nm radiation only, increased curing extent relative to that of the unpigmented reference composition was observed at 3, 30, and 180 s exposure durations. When the photocurable composition was irradiated with 278 nm radiation only, negligible increase in curing extent at all exposure duration was observed. In contrast, when irradiated simultaneously with radiation at the single peak wavelengths of 278 nm and 265 nm, full cure was achieved at all exposure durations (3, 30, 180 s), indicating a synergistic effect when irradiating at the two simultaneous wavelengths.

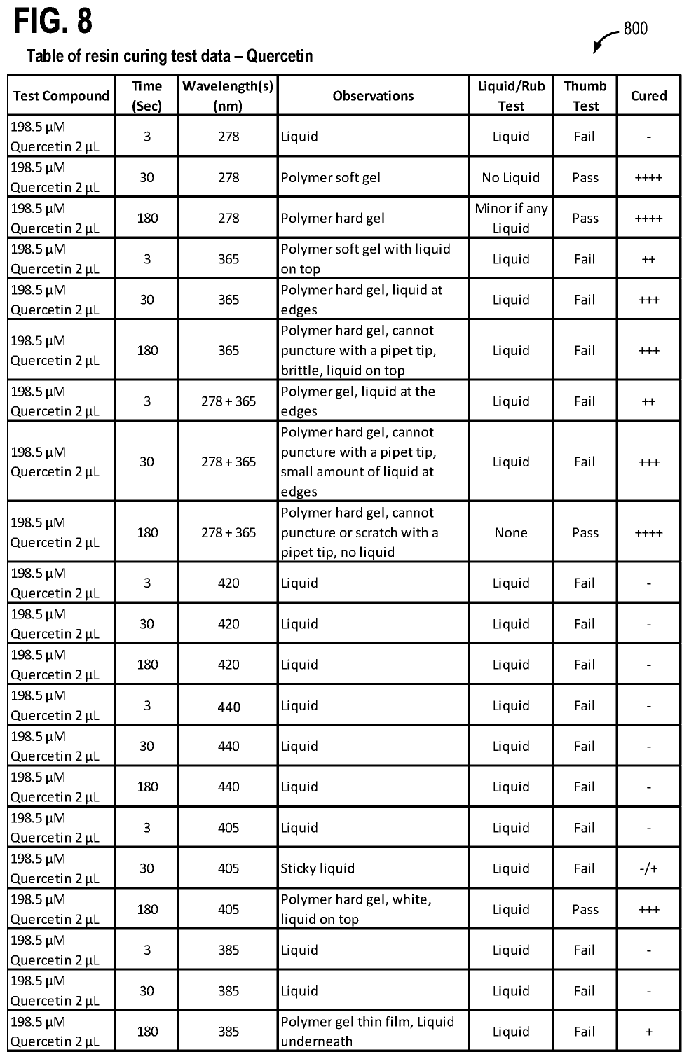

Turning now to FIG. 8, it illustrates a data table 800 for photocurable compositions including 198.5 μM quercetin aqueous solution mixed with 50 μL of the 10%:90% CN1000:CD564 unpigmented reference composition. When the photocurable composition was irradiated with 365 nm radiation only, increased curing extent relative to that of the unpigmented reference composition was observed at 3, 30, and 180 s exposure durations. When the photocurable composition was irradiated with 278 nm radiation only, full cure was achieved after 30 s and 180 s of exposure. In contrast, when irradiated simultaneously with radiation at the single peak wavelengths of 278 nm and 265 nm, full cure was achieved at 180 s of exposure, which is equivalent to the curing performance of the unpigmented reference composition. Other irradiation wavelengths of 420, 440, and 405 nm showed no increase in curing extent over the unpigmented reference composition.

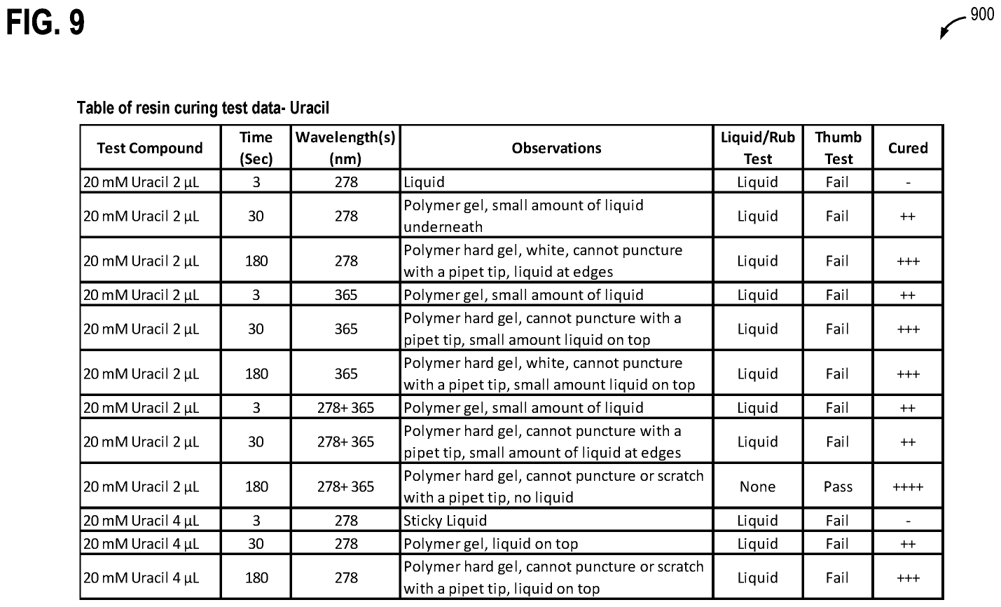

Turning now to FIG. 9, it illustrates a data table 900 for photocurable compositions including 20 mM uracil aqueous solution mixed with 50 μL of the 10%:90% CN1000:CD564 unpigmented reference composition. When the photocurable composition was irradiated with 365 nm radiation only, slight increased curing extent relative to that of the unpigmented reference composition was observed at 3, 30, and 180 s exposure durations. Similarly, when the photocurable composition was irradiated with 278 nm radiation only, some increased curing extent, but not full curing, relative to that of the unpigmented reference composition was observed at 3, 30, and 180 s exposure durations. Doubling the concentration (e.g., doubling volume added from 2 μL to 4 μL) of uracil did not further increase curing extent. When the photocurable composition was irradiated simultaneously with radiation at the single peak wavelengths of 278 nm and 265 nm, full cure was achieved at 180 s of exposure, which is equivalent to the curing performance of the unpigmented reference composition.

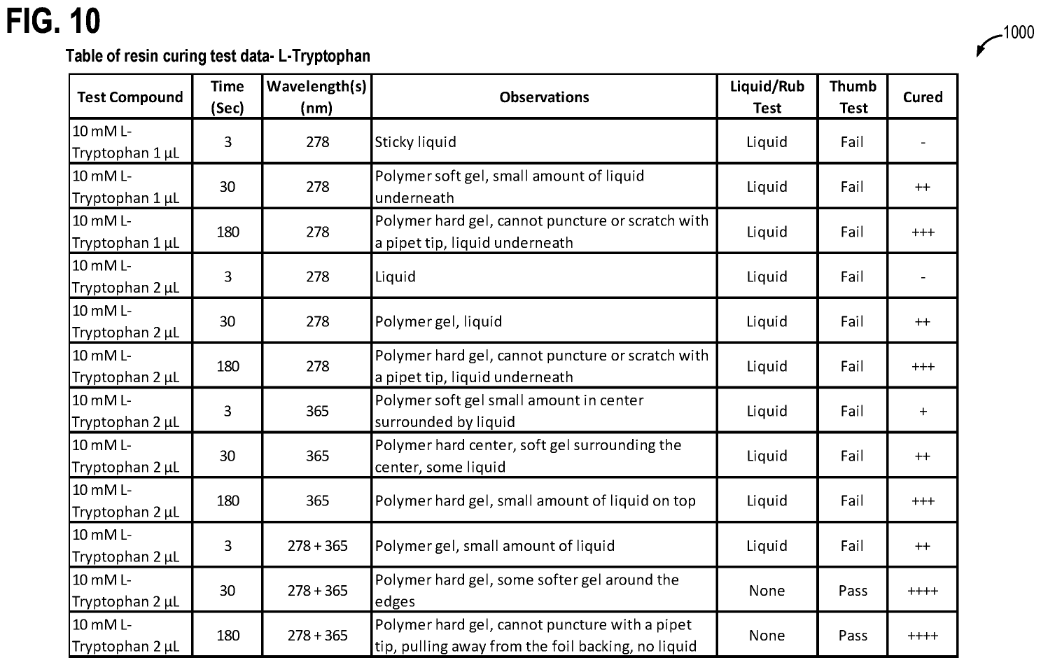

Turning now to FIG. 10, it illustrates a data table 1000 for photocurable compositions including 10 mM L-tryptophan aqueous solution mixed with 50 μL of the 10%:90% CN1000:CD564 unpigmented reference composition. When the photocurable composition was irradiated with 365 nm radiation only, slight increased curing extent relative to that of the unpigmented reference composition was observed at 3, 30, and 180 s exposure durations. Similarly, when the photocurable composition was irradiated with 278 nm radiation only, further increased curing extent, but not full curing, relative to that of the unpigmented reference composition was observed at 3, 30, and 180 s exposure durations. Doubling the concentration (e.g., doubling volume added from 1 μL to 2 μL) of L-tryptophan did not further increase curing extent at 278 nm. When the photocurable composition was irradiated simultaneously with radiation at the single peak wavelengths of 278 nm and 265 nm, increased cure extent was achieved at 3 s of exposure, relative to the unpigmented reference composition.

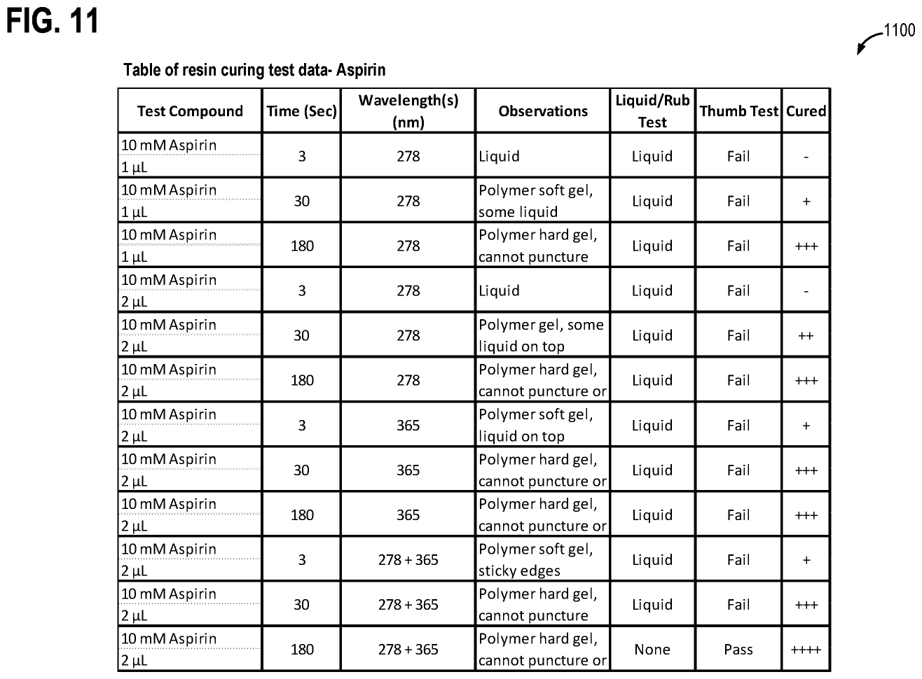

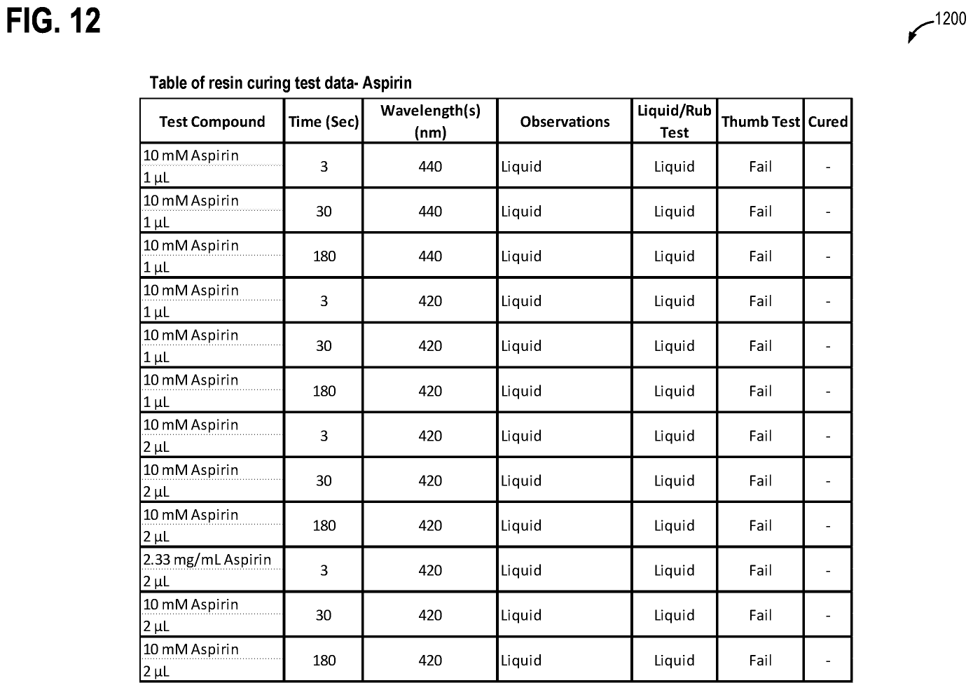

Turning now to FIGS. 11 and 12, they illustrate data tables 1100 and 1200 for photocurable compositions including 10 mM aspirin aqueous solution mixed with 50 μL of the 10%:90% CN1000:CD564 unpigmented reference composition. When the photocurable composition was irradiated with 365 nm radiation only, increased curing extent relative to that of the unpigmented reference composition was observed at 3, 30, and 180 s exposure durations. Similarly, when the photocurable composition was irradiated with 278 nm radiation only, further increased curing extent, but not full curing, relative to that of the reference composition was observed at 3, 30, and 180 s exposure durations. Doubling the concentration (e.g., doubling volume added from 1 μL to 2 μL) of aspirin exhibited a significant increase in curing extent. Furthermore, when the photocurable composition was irradiated simultaneously with radiation at the single peak wavelengths of 278 nm and 265 nm, increased cure extent was achieved at 3 and 30 s of exposure, relative to the unpigmented reference composition. Exposure of the photocurable composition to 420 and 440 nm wavelength radiation did not cure, which is equivalent to the unpigmented reference composition.

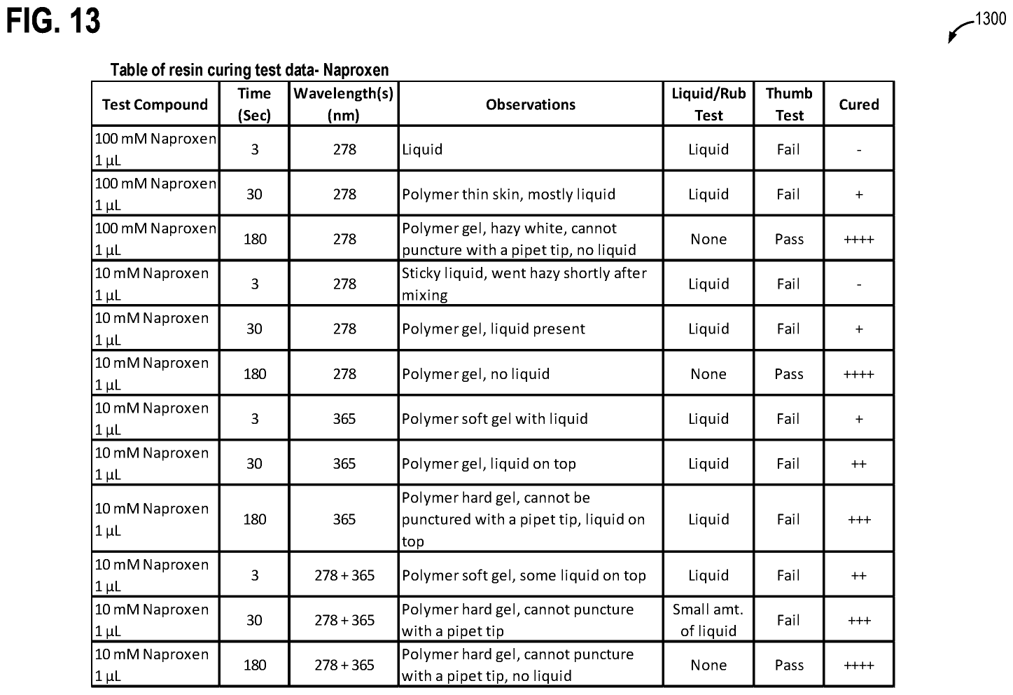

Turning now to FIG. 13, it illustrates a data table 1300 for photocurable compositions including 1 μL of 10 mM or 100 mM naproxen aqueous solution mixed with 50 μL of the 10%:90% CN1000:CD564 unpigmented reference composition. When the photocurable composition was irradiated with 365 nm radiation only, slight increased curing extent relative to that of the unpigmented reference composition was observed. In contrast, when the photocurable composition was irradiated with 278 nm radiation only, full cure is achieved for both 10 mM and 100 mM solutions. However, increasing the naproxen concentration from 10 mM to 100 mM did not noticeably increase curing extent at 278 nm. When the photocurable composition was irradiated simultaneously with radiation at the single peak wavelengths of 278 nm and 265 nm, slightly increased cure extent was achieved relative to the unpigmented reference composition.

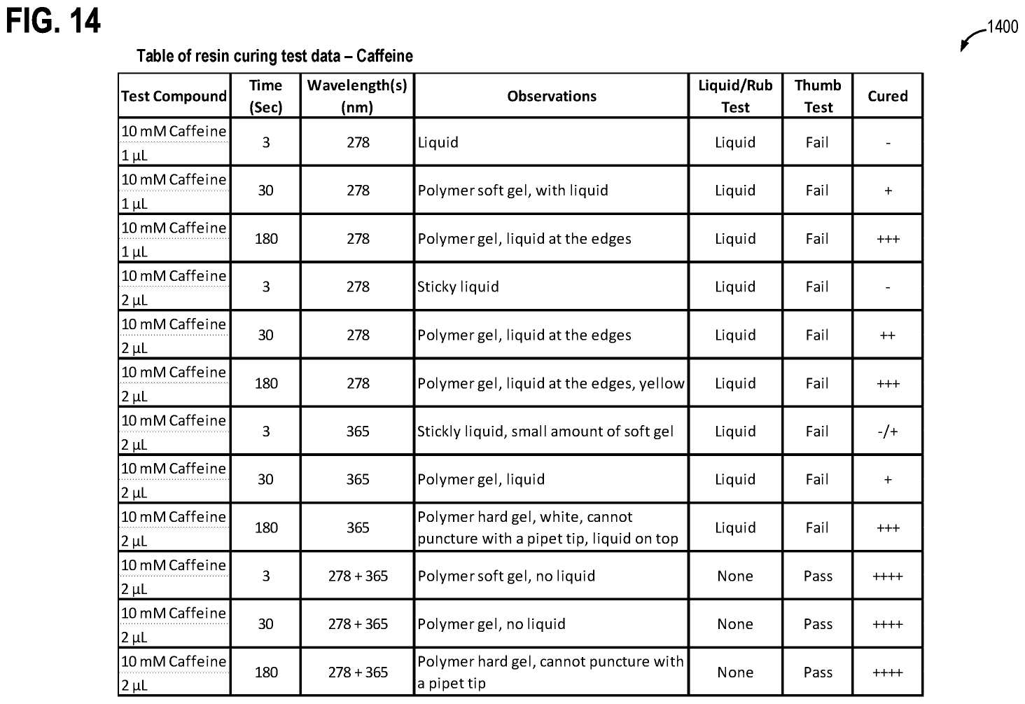

Turning now to FIG. 14, it illustrates a data table 1400 for photocurable compositions including 10 mM caffeine aqueous solution mixed with 50 μL of the 10%:90% CN1000:CD564 unpigmented reference composition. When the photocurable composition was irradiated with 365 nm radiation only, slight increased curing extent relative to that of the unpigmented reference composition was observed. In contrast, when the photocurable composition was irradiated with 278 nm radiation only, increased curing extent relative to the unpigmented reference composition is achieved. Doubling the concentration (e.g., doubling the volume of caffeine added from 1 μL to 2 μL) achieved a further slight increase in curing extent at 278 nm irradiation. When the photocurable composition was irradiated simultaneously with radiation at the single peak wavelengths of 278 nm and 265 nm, full cure extent was achieved at all exposure durations, a significant increase in curing performance relative to the unpigmented reference composition.

Turning now to FIG. 15, it shows a data table 1500 of proofer curing test data for a pigmented reference composition (e.g., mix base 2905). The pigmented reference composition, MNA857 blue ink base (formulated ink composition without photoiniatior), was irradiated at 395 nm, 365 nm, 278 nm, and at 365 nm and 278 nm simultaneously. In the last trial, emulsifier A (E-A), SSL, was admixed to the pigmented reference composition. The pigmented reference composition exhibited some slight curing with the exposure to the combined 278 nm+365 nm wavelength radiation, with and without the emulsifier A, which is consistent with the cure tests for the unpigmented reference composition (see FIGS. 1-2). No curing was observed when the pigmented reference composition was irradiated at each single peak wavelength of 395, 365, and 278 nm, individually. The MNA857 blue ink based failed to cure satisfactorily in the absence ofany photoinitiator added to the MNA857 blue ink base.

Turning now to FIG. 16, it shows a data table 1600 of proofer curing test data for a photocurable composition including emulsifier A (SSL) admixed with resin CN1000 prior to admixing with the pigmented reference composition, and without photoinitiator. Adding SSL to the pigmented reference composition resulted in a small increase in curing extent relative to the pigmented reference composition alone, but did not achieve full cure during each of the test conditions. At 8 mg/100 μL, the emulsifier did not fully suspend, and further testing indicated a preferred upper emulsifier concentration of 6 mg/100 μL.

Turning now to FIG. 17, it shows a data table 1700 of proofer curing test data for a photocurable composition including emulsifier B (LPC) admixed with the pigmented reference composition, and without photoinitiator. Emulsifier B was admixed at a concentration of 1 mg/100 μL in water, ethanol, and in CN1000 in each respective test case. Similar to the results for addition of SSL, adding LPC to the pigmented reference composition resulted in a small increase in curing extent relative to the pigmented reference composition alone, but did not achieve full cure during each of the test conditions. Incorporation of even small amounts of ethanol into the photocurable composition resulted in spattering and fire potential upon exposure to higher intensity radiation at 278, 265, and 395 nm. As such, photocurable compositions including more highly flammable solvents may be avoided to reduce a risk of ignition during curing. Repeated vortexing and sonication at 37 degrees Celsius was performed to achieve suspension of the emulsifier in CN1000 resin.

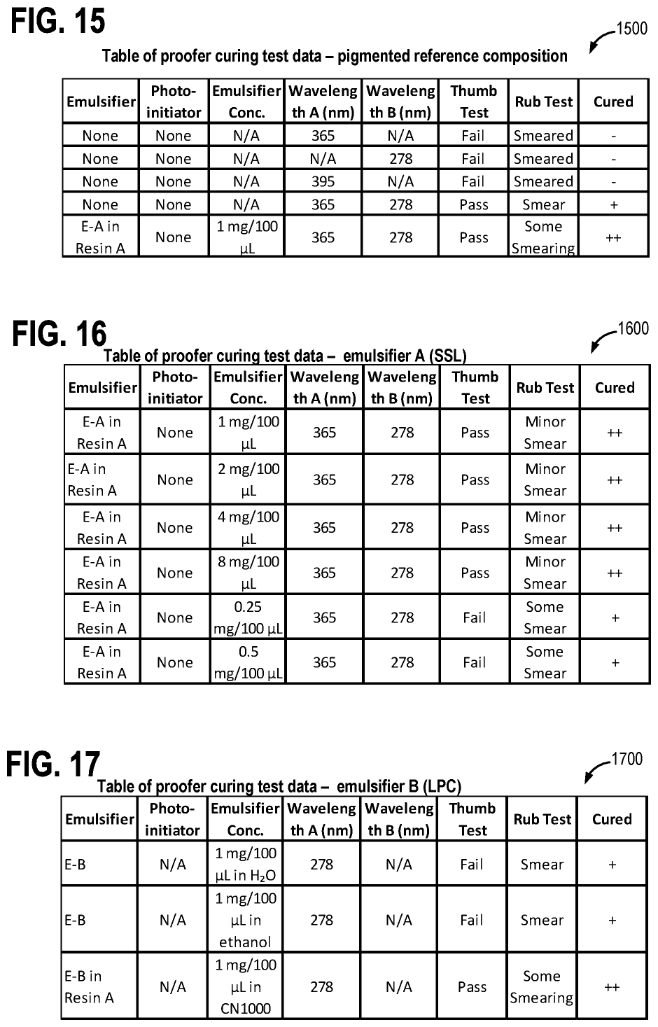

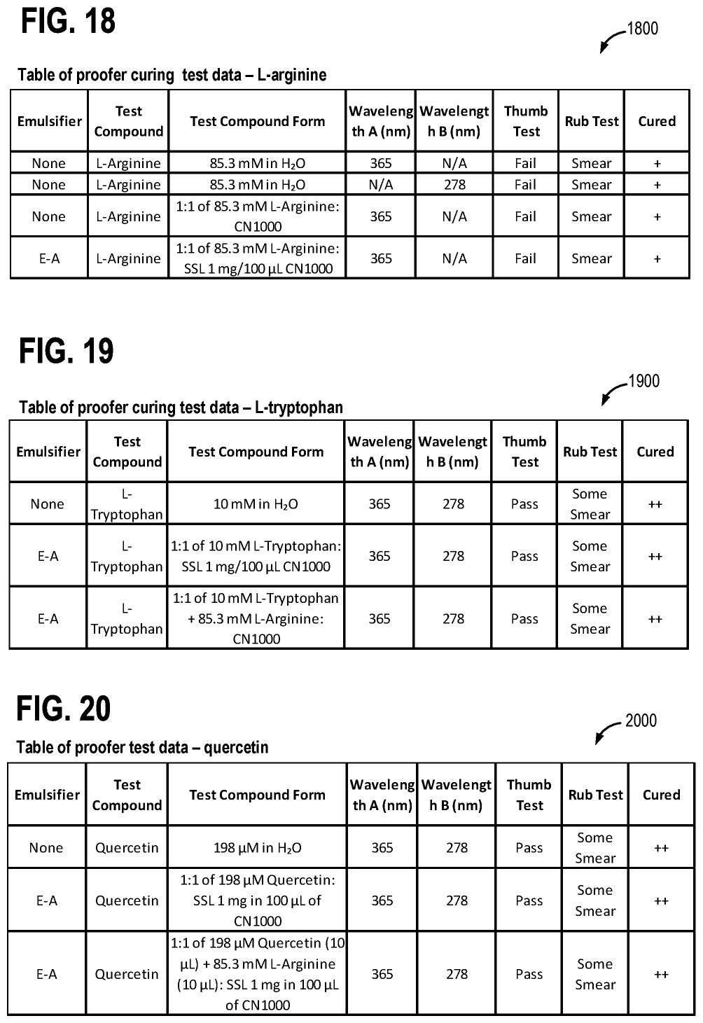

Turning now to FIG. 18, it shows a data table 1800 of proofer curing test data for a photocurable composition including an electron donor, L-arginine, admixed to the pigmented reference composition. In each test case, 10 μL of the test compound form was added to 100 μL of the pigmented reference composition. The electron donor was added at a concentration of 85.3 mM in water, suspended in CN1000, or admixed with SSL in CN1000, in each of the test cases. Addition of L-arginine did not exhibit increased curing extent relative to the pigmented reference composition.

Turning now to FIG. 19, it shows a data table 1900 of proofer curing test data for a photocurable composition including a biocompatible initiator mixture 2950 including photoinitiator, L-tryptophan added to the pigmented reference composition. In each test case, 10 μL of the test compound form was added to 100 μL of the pigmented reference composition. In some cases, an emulsifier (SSL) is added to aid in emulsifying the photoinitiator with the pigmented reference composition. Addition of L-tryptophan with the emulsifier did not exhibit increased curing extent relative to the pigmented reference composition.

Turning to FIG. 20, it shows a data table 2000 of proofer curing test data for a photocurable composition including a biocompatible photoinitiator, quercetin, added to the pigmented reference composition. In each test case, 10 μL of the test compound form was added to 100 μL of the pigmented reference composition. In some cases, an emulsifier (SSL) is added to aid in emulsifying the photoinitiator with the pigmented reference composition. Addition of quercetin, with or without the emulsifier, in the absence of other photoinitiator compounds did not exhibit increased curing extent relative to the pigmented reference composition.

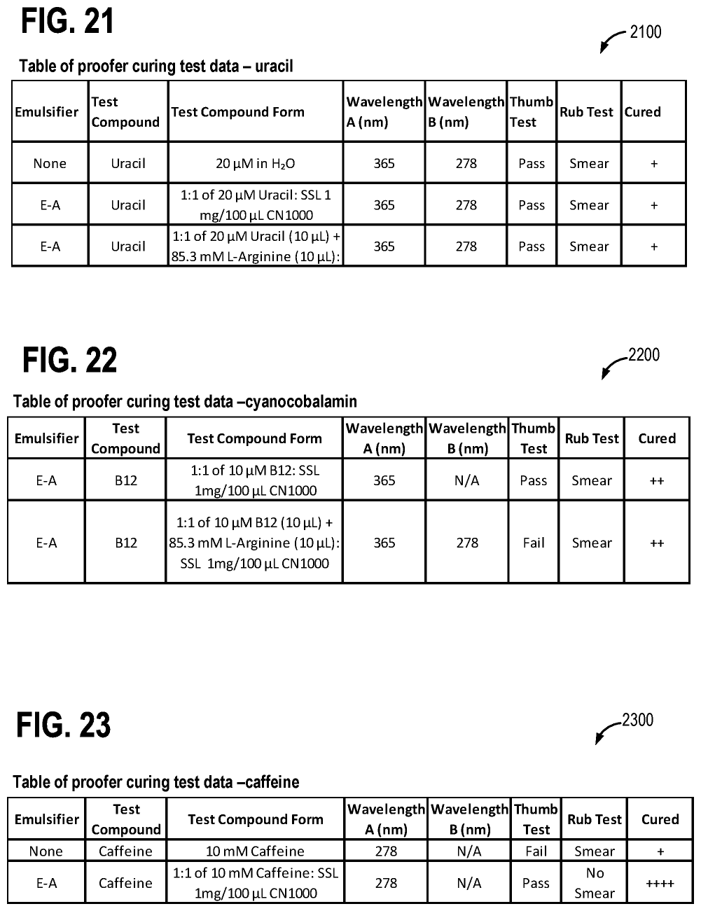

Turning to FIG. 21, it shows a data table 2100 of proofer curing test data for a photocurable composition including a biocompatible photoinitiator, uracil, added to the pigmented reference composition. In each test case, 10 μL of the test compound form was added to 100 μL of the pigmented reference composition. In some cases, an emulsifier (SSL) is added to aid in emulsifying the photoinitiator with the pigmented reference composition. Addition of uracil, with or without the emulsifier, in the absence of other photoinitiator compounds did not exhibit increased curing extent relative to the pigmented reference composition.

Turning to FIG. 22, it shows a data table 2200 of proofer curing test data for a photocurable composition including a biocompatible photoinitiator, cyanocobalamin, added to the pigmented reference composition. In each test case, 10 μL of the test compound form was added to 100 μL of the pigmented reference composition. Furthermore, an emulsifier (SSL) is added to aid in emulsifying the photoinitiator with the pigmented reference composition. In one case, an electron donor (L-arginine) is admixed with the photoinitiator mixture. Addition of cyanocobalamin in the absence of other photoinitiator compounds, and including the emulsifier but without the electron donor, did not exhibit increased curing extent relative to the pigmented reference composition. In contrast, addition of the photoinitiator with the electron donor increased curing extent relative to the pigmented reference composition, and also increased curing extent relative to the pigmented reference composition with L-arginine but without photoinitiator (FIG. 18). With the concentration of cyanocobalamin being lower (e.g., 10 μM), increasing the concentration of cyanocobalamin may further increase curing extent.

Turning now to FIG. 23, it shows a data table 2300 of proofer curing test data for a photocurable composition including a biocompatible photoinitiator, caffeine, added to the pigmented reference composition. In each test case, 10 μL of the test compound form was added to 100 μL of the pigmented reference composition. In one case, an emulsifier (SSL) is added to aid in emulsifying the photoinitiator with the pigmented reference composition. Addition of caffeine and the emulsifier (SSL) to the pigmented reference composition resulted in a full cure of the photocurable composition when irradiated with radiation at 278 nm wavelength. In contrast, addition of caffeine to the pigmented reference composition without the emulsifier failed to cure, indicating that emulsification of the photoinitiator aids in increasing extent of cure; in particular without the emulsifier, addition of caffeine alone fails to aid in increasing extent of cure.

As previously described with reference to FIG. 16, the photocurable composition including SSL demonstrated some added photocuring in the absence of added photoinitiators relative to the case without SSL. In contrast, FIG. 23 indicates that addition of caffeine to the photocurable composition exhibits full curing in the presence of SSL but not in its absence. As such, addition of the combination of caffeine (a biocompatible initiator) and an emulsifier (SSL) to the photocurable composition results in increased cure relative to photocurable compositions with either caffeine or SSL added individually. This synergistic effect may be due to increased mixing and incorporation of the caffeine into the photocurable composition in the presence of SSL emulsifier in the photocurable composition, and from the increased contribution to curing from the presence of SSL.

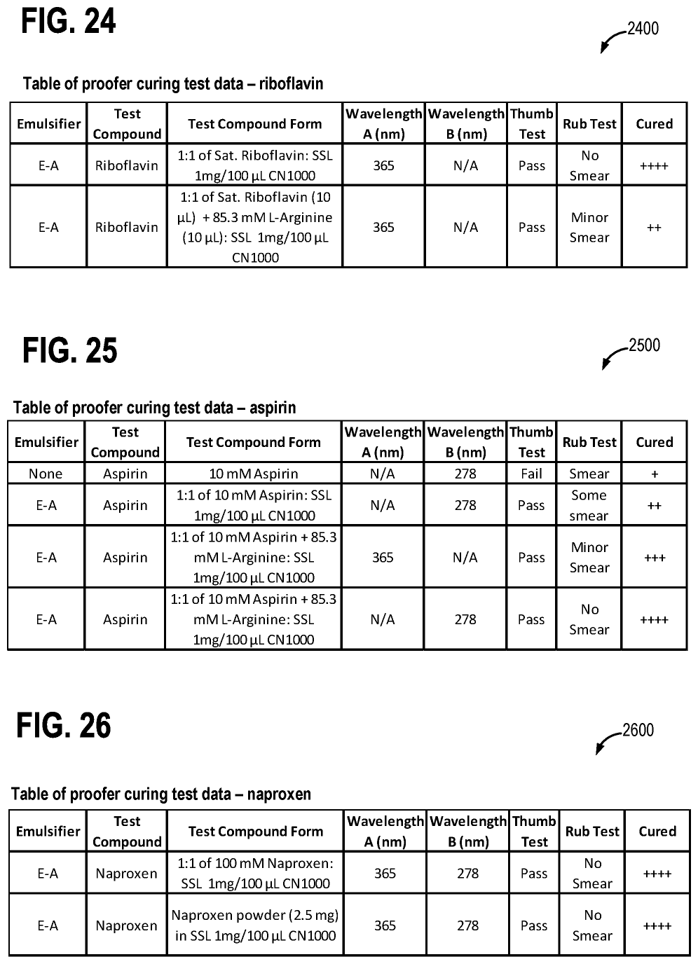

Turning now to FIG. 24, it shows a table 2400 of proofer curing test data for a photocurable composition including a biocompatible photoinitiator, riboflavin, added to the pigmented reference composition. In each test case, 10 μL of the test compound form was added to 100 μL of the pigmented reference composition. In one case, a 1:1 ratio of saturated (12 mg/mL) aqueous riboflavin solution to emulsifier (SSL) at 1 mg/100 μL of CN1000 resin was admixed to the pigmented reference composition and irradiated at 365 nm. In another case, a 1:1 ratio of saturated (12 mg/mL) aqueous riboflavin solution and 85.3 mM of electron donor (L-arginine) to emulsifier (SSL) at 1 mg/100 μL of CN1000 resin was admixed to the pigmented reference composition and irradiated at 365 nm. The photocurable composition with riboflavin and without the electron donor (L-arginine) achieved higher curing extent as compared to the photocurable composition with riboflavin and L-arginine. Furthermore, incorporation of the riboflavin with the emulsifier (SSL) prior to addition of the photoinitiator mixture to the pigmented reference composition (mix base 2905) resulted in full cure of the pigmented photocurable composition.

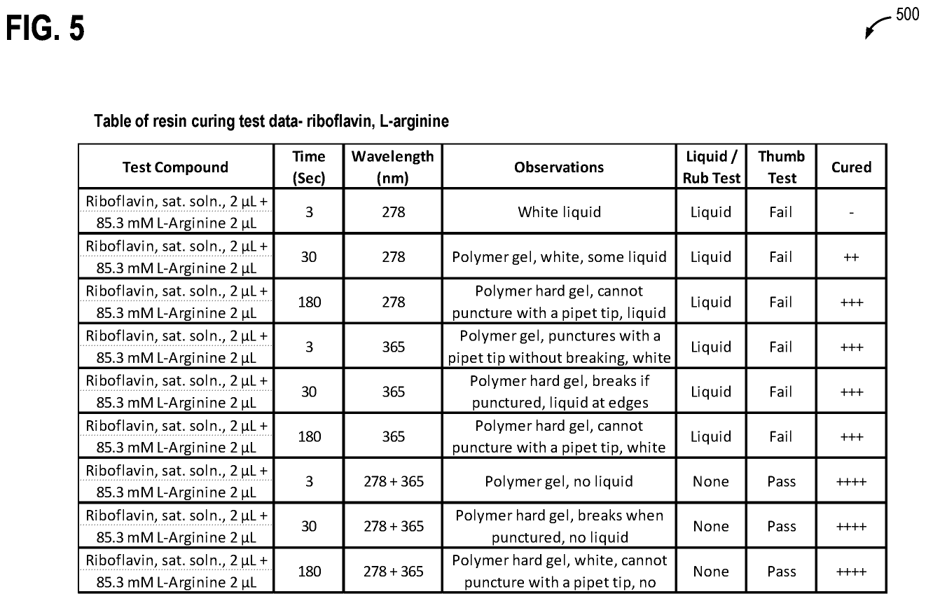

Although the photocurable composition including L-arginine and riboflavin aided curing for the case of the unpigmented reference composition (see FIG. 5), a similar improvement in curing was not observed for addition of L-arginine and riboflavin to the pigmented reference composition. As previously described, the pigmented reference composition, MNA857 is a blue pigmented ink composition, which reflects wavelengths in the range of 420-440 nm, where L-arginine is activated for triggering photoinitiation. The reflection of radiation over these wavelengths may cause photocuring of blue inks to be more difficult than other pigmented ink compositions.

Turning now to FIG. 25, it shows a table 2500 of proofer curing test data for a photocurable composition including a biocompatible photoinitiator, aspirin, added to the pigmented reference composition. In each test case, 10 μL of the test compound form was added to 100 μL of the pigmented reference composition. Three different photoinitiator mixtures were tested with the pigmented reference composition: aspirin without emulsifier (SSL) and without electron donor (L-arginine); aspirin with emulsifier and without electron donor; and aspirin with emulsifier and electron donor. The test case for the biocompatible photoinitiator mixture including aspirin, emulsifier (SSL), and electron donor (L-arginine) that was irradiated at 278 nm achieved full cure of the photocurable composition. Furthermore, the test case for the biocompatible photoinitiator mixture including aspirin, emulsifier (SSL), and electron donor (L-arginine) that was irradiated at 365 nm achieved increased cure of the photocurable composition relative to the pigmented reference composition with emulsifier (SSL) and without photoinitiator.

Turning now to FIG. 26, it shows a table 2600 of proofer curing test data for a photocurable composition including a biocompatible photoinitiator, naproxen, added to the pigmented reference composition. In each test case, 10 μL of the test compound form was added to 100 μL of the pigmented reference composition. Two different photoinitiator mixtures were tested with the pigmented reference composition: 10 mM naproxen solution with emulsifier (SSL) and without electron donor; and naproxen powder (2.5 mg) with emulsifier (SSL) and without electron donor. Naproxen, either in aqueous solution or in powder form, when admixed with the emulsifier, prior to admixing with the pigmented reference composition, resulted in full cure of the photocurable composition when irradiated with 365 nm and 278 nm single peak wavelengths simultaneously. Direct mixing of naproxen powder obviates a step of solubilizing the naproxen in water and is also advantageous because it lowers an amount and duration of post-cure drying and risks of curing defects due to water vaporization during photocuring.

Turning now to FIG. 27, it illustrates a flow chart for a method 2700 of preparing and curing a photocurable composition. Method 2700 begins at 2705 where a biocompatible initiator mixture is prepared. Preparing the biocompatible initiator mixture may include selecting one or more biocompatible initiators at 2705. Selecting the biocompatible initiator may further include determining a preferred concentration of the biocompatible initiator. Examples of preferred concentrations of aqueous solutions and powdered biocompatible initiators are listed in Table 1. Examples of more preferred concentrations are shown herein with reference to the curing data tables of FIGS. 3-26. Selecting a plurality of photoinitiators may be advantageous when photocuring the photocurable composition includes irradiation of the photocured composition at multiple single peak wavelengths. For example, caffeine and/or aspirin may be included in the photinitiator mixture to increase curing extent when the photocurable composition is irradiated with radiation at 278 nm (see FIGS. 23 and 25), and riboflavin may further be included in the photoinitiator mixture to aid in increasing curing extent responsive to irradiating the photocurable composition with radiation at 365 nm (see FIG. 24).

Next, at 2720, method 2700 continues with selection of one or more biocompatible electron donors and/or one or more quenchers. Examples of preferred concentrations of aqueous solutions and powdered biocompatible electron donors and/or quenchers are listed in Table 3. Examples of more preferred concentrations are shown herein with reference to the curing data tables of FIGS. 3-26. An electron donor and/or quencher may be included in the photoinitiator mixture to aid in increasing curing extent of the photocurable composition. For example, preliminary testing indicates that L-arginine electron donor may increase curing extent when admixed to the photoinitiator mixture with caffeine, especially under conditions when an the photocurable composition is irradiated with an additional radiation with wavelengths from 420 nm to 440 nm); similar increases in curing extent may be indicated when TEA and TEA-HCl electron donors are admixed to the photoinitiator mixture.

Next, at 2730, method 2700 continues with selection of one or more biocompatible emulsifiers. Examples of preferred concentrations of aqueous solutions and powdered biocompatible electron donors and/or quenchers are listed in Table 2. Examples of more preferred concentrations are shown herein with reference to the curing data tables of FIGS. 3-26. The biocompatible emulsifiers may include one or more of SSL, LPC, and/or 2HEC, as described herein. Inclusion of a biocompatible emulsifier may aid in achieving a more compatible and homogeneous photocurable composition, in particular during conditions when the biocompatible photoinitiator mixture is more polar (e.g., aqueous or polar solution) and the mix base 2905 is more non-polar (e.g., organic-vehicle based). Achieving a more compatible and homogeneous photocurable composition can advantageously increase curing kinetics and/or extent of curing by aiding in thorough mixing and distribution of the photoinitiator in the photocurable composition. At 2740, method 2700 continues whereby the biocompatible photoinitiator mixture is mixed. Here, the biocompatible photoinitiator mixture includes one or more of a biocompatible photoinitiator, a biocompatible electron donor and/or quencher, and a biocompatible emulsifier. Mixing the biocompatible photoinitiator mixture may include various methods of applying shear rate to the photoinitiator mixture such as sonicating and vortexing.

Next, method 2700 continues at 2750 where the mix base is selected. The mix base, as described herein, may include one or more of a resin, vehicle (e.g., solvent, diluent), a pigment, and a biocompatible emulsifier. In some examples, both the photoinitiator mixture and the mix base may include one or more biocompatible emulsifiers; in other examples, one of the photoinitiator mixture and the mix base may include a biocompatible emulsifier. In other cases, neither the mix base nor the photoinitiator mixture includes a biocompatible emulsifier. A photocurable composition without a biocompatible emulsifier may be advantageous in simplifying the complexity of the photocurable composition.

During conditions where the photocurable composition includes a biocompatible emulsifier, at 2760, the selected biocompatible emulsifier is admixed into the photoinitiator mixture and/or the mix base prior to mixing the biocompatible initiator mixture with the mix base. In this way, emulsification and homogeneous mixing of the photoinitiator mixture with the mix base can be aided. Mixing the photoinitiator mixture with the mix base prior to addition of the emulsifier may increase a risk of inhomogeneous mixing and emulsification of the initiator in the photocurable composition, thereby reducing curing extent thereof.

Next, method 2700 continues at 2770 where the biocompatible initiator mixture is mixed with the mix base. Mixing the photoinitiator mixture with the mix base may include sonication, vortexing, and other higher shear mixing methods.

Next, method 2700 continues at 2780, where the biocompatible photocurable composition is irradiated. As described herein with reference to Table 4, the photocurable composition may be irradiated using one or more radiation sources that emit radiation at one or multiple single peak wavelengths. Curing extent can be increased given a specific radiation intensity and exposure duration when the wavelength of the emitted radiation more closely matches the peak absorbance wavelength of the biocompatible photoinitiator. Commercial availability of radiation sources may limit the single peak wavelengths available, as suggested in Table 4. Irradiation of multiple single peak wavelengths may aid in increasing curing extent when a photoinitiator mixture is characterized by radiation absorption peaks at those multiple single peak wavelengths. Irradiation of multiple single peak wavelengths may include simultaneous irradiation of the photocurable composition with the multiple single peak wavelength radiation. After 2780, method 2700 ends.

In one example, the irradiated biocompatible photocurable composition may include packaging material such as FCM for a food or pharmaceutical product including direct-printed, digitally printed, flexographic printed, and screen printed films, plastic bottles, bags, cardboard, paper, and other types of packaging. In another representation, packaging for a food or pharmaceutical contact material may include a biocompatible photocurable composition, comprising, a photoinitiator mixture, consisting only of a mixture of biocompatible compounds, including one or more of naproxen, caffeine, uracil, quercetin, and cyanocobalamin, and a polymer resin.

Referring now to FIG. 28, it illustrates a block diagram for an example configuration of a lighting device 2800. In one example, lighting device 2800 may comprise a light-emitting subsystem 2812, a control system 2814, a power source 2816 and a cooling subsystem 2818. The light-emitting subsystem 2812 may comprise a plurality of semiconductor devices 2819. The plurality of semiconductor devices 2819 may include a linear or two-dimensional array 2820 of radiation-emitting elements such as an array of light-emitting elements such as LED devices, for example. In other examples, the radiation-emitting elements may include other radiation-emitting electronic components such as transistors (e.g., MOSFET), CPU processors, power source, and the like. Semiconductor devices 2819 may provide radiant output 2824, including one or more of visible light, ultra-violet (UV) light, and infrared (IR) radiation. The radiant output 2824 may be directed to a workpiece 2826 located at a fixed plane from lighting device 2800. Returned radiation 2828 may be retro-reflected back to the light-emitting subsystem 2812 from the workpiece 2826 (e.g., via reflection of the radiant output 2824). In some examples, the workpiece 2826 may include a retro-reflective surface.

The radiant output 2824 may be directed to the workpiece 2826 via coupling optics 2830. The coupling optics 2830, if used, may be variously implemented. As an example, the coupling optics may include one or more layers, materials or other structures interposed between the semiconductor devices 2819 and workpiece 2826, and providing radiant output 2824 to surfaces of the workpiece 2826. As an example, the coupling optics 2830 may include a micro-lens array to enhance collection, condensing, collimation or otherwise the quality or effective quantity of the radiant output 2824. As another example, the coupling optics 2830 may include a micro-reflector array. In employing such a micro-reflector array, each semiconductor device providing radiant output 2824 may be disposed in a respective micro-reflector, on a one-to-one basis. As another example, a linear array of semiconductor devices 2820 providing radiant output 2824 may be disposed in macro-reflectors, on a many-to-one basis. In this manner, coupling optics 2830 may include both micro-reflector arrays, wherein each semiconductor device is disposed on a one-to-one basis in a respective micro-reflector, and macro-reflectors wherein the quantity and/or quality of the radiant output 2824 from the semiconductor devices is further enhanced by macro-reflectors. Lighting device 2800 may further include a transparent window 2864 interposed between the coupling optics 2830 and the workpiece 2826.

Each of the layers, materials or other structure of coupling optics 2830 may have a selected index of refraction. By properly selecting each index of refraction, reflection at interfaces between layers, materials and other structures in the path of the radiant output 2824 (and/or retro-reflected radiation 2828) may be selectively controlled. As an example, by controlling differences in such indexes of refraction at a selected interface, for example window 2864, disposed between the semiconductor devices to the workpiece 2826, reflection at that interface may be reduced or increased so as to enhance the transmission of radiant output at that interface for ultimate delivery to the workpiece 2826. For example, the coupling optics may include a dichroic reflector where certain wavelengths of incident light are absorbed, while others are reflected and focused to the surface of workpiece 2826.

The coupling optics 2830 may be employed for various purposes. Example purposes include, among others, to protect the semiconductor devices 2819, to retain cooling fluid associated with the cooling subsystem 2818, to collect, condense and/or collimate the radiant output 2824, to collect, direct or reject retro-reflected radiation 2828, or for other purposes, alone or in combination. As a further example, the lighting device 2800 may employ coupling optics 2830 so as to enhance the effective quality, uniformity, or quantity of the radiant output 2824, particularly as delivered to the workpiece 2826.

As a further example, coupling optics 2830 may comprise a cylindrical lens through which light emitted from the linear array of radiation-emitting elements is directed. As previously described, light emitted from the linear array of radiation-emitting elements may be incident at an incident face of the cylindrical lens, and may be collimated and redirected out of an emitting face of the cylindrical lens. The cylindrical lens may include one or more of a rod lens, a semi-circular lens, a plano-convex lens, a bi-convex lens, and a faceted Fresnel lens. The cylindrical lens may include a cylindrical lens having a cylindrical power axis and an orthogonal plano axis, for collimating and/or focusing the light emitted from the linear array 2820 of semiconductor devices 2819.

Selected of the plurality of semiconductor devices 2819 may be coupled to the control system 2814 via coupling electronics 2822, so as to provide data to the control system 2814. Control system 2814 may include a plurality of controllers working in tandem to control operation of the lighting device. As further described herein, control system 2814 may further include multiple controllers configured to operate in a master-slave cascading control scheme. As described further below, the control system 2814 may also be implemented to control such data-providing semiconductor devices, for example, via the coupling electronics 2822. The control system 2814 may be electrically connected to, and may be implemented to control, the power source 2816, and the cooling subsystem 2818. Moreover, the control system 2814 may transmit and/or receive data from power source 2816 and cooling subsystem 2818. In one example, the irradiance at one or more locations at the workpiece 2826 surface may be detected by sensors and transmitted to control system 2814 in a feedback control scheme. In a further example, control system 2814 may communicate with a controller of another lighting system (not shown in FIG. 28) to coordinate control of both lighting systems. For example, control system 2814 of multiple lighting systems may operate in a master-slave cascading control algorithm, where the set point of one or more of the controllers is set by the output of the other controller. Other control strategies for operation of lighting device 2800 in conjunction with another lighting system may also be used. As another example, control system 2814 for multiple lighting systems arranged side by side may control lighting systems in an identical manner for increasing uniformity of irradiated light across multiple lighting systems.

In addition to the power source 2816, cooling subsystem 2818, and light-emitting subsystem 2812, the control system 2814 may also be connected to, and implemented to control internal element 2832, and external element 2834. Element 2832, as shown, may be internal to the lighting device 2800, while element 2834, as shown, may be external to the lighting device 2800, but may be associated with the workpiece 2826 (e.g., handling, cooling or other external equipment) or may be otherwise related to a photoreaction (e.g. curing) that lighting device 2800 supports.

The data received by the control system 2814 from one or more of the power source 2816, the cooling subsystem 2818, the light-emitting subsystem 2812, and/or elements 2832 and 2834, may be of various types. As an example, the data may be representative of one or more characteristics associated with coupled semiconductor devices 2819. As another example, the data may be representative of one or more characteristics associated with the respective light-emitting subsystem 2812, power source 2816, cooling subsystem 2818, internal element 2832, and external element 2834 providing the data. As still another example, the data may be representative of one or more characteristics associated with the workpiece 2826 (e.g., representative of the radiant output energy or spectral component(s) directed to the workpiece). Moreover, the data may be representative of some combination of these characteristics.

The control system 2814, in receipt of any such data, may be implemented to respond to that data. For example, responsive to such data from any such component, the control system 2814 may be implemented to control one or more of the power source 2816, cooling subsystem 2818, light-emitting subsystem 2812 (including one or more such coupled semiconductor devices), and/or the elements 2832 and 2834. As an example, responsive to data from the light-emitting subsystem indicating that the light energy is insufficient at one or more points associated with the workpiece, the control system 2814 may be implemented to either (a) increase the power source's supply of power to one or more of the semiconductor devices, (b) increase cooling of the light-emitting subsystem via the cooling subsystem 2818 (e.g., certain light-emitting devices, if cooled, provide greater radiant output), (c) increase the time during which the power is supplied to such devices, or (d) a combination of the above.

Individual semiconductor devices 2819 of the light-emitting subsystem 2812 may be controlled independently by control system 2814. For example, control system 2814 may control a first group of one or more individual LED devices to emit light of a first intensity, wavelength, and the like, while controlling a second group of one or more individual LED devices to emit light of a different intensity, wavelength, and the like. The first group of one or more individual LED devices may be within the same linear array 2820 of semiconductor devices, or may be from more than one linear array of semiconductor devices 2820 from multiple lighting devices 2800. Linear array 2820 of semiconductor device may also be controlled independently by control system 2814 from other linear arrays of semiconductor devices in other lighting systems. For example, the semiconductor devices of a first linear array may be controlled to emit light of a first intensity, wavelength, and the like, while those of a second linear array in another lighting system may be controlled to emit light of a second intensity, wavelength, and the like.

As a further example, under a first set of conditions (e.g. for a specific workpiece, photoreaction, and/or set of operating conditions) control system 2814 may operate lighting device 2800 to implement a first control strategy, whereas under a second set of conditions (e.g. for a specific workpiece, photoreaction, and/or set of operating conditions) control system 2814 may operate lighting device 2800 to implement a second control strategy. As described above, the first control strategy may include operating a first group of one or more individual semiconductor devices 2819 to emit light of a first intensity, wavelength, and the like, while the second control strategy may include operating a second group of one or more individual LED devices to emit light of a second intensity, wavelength, and the like. The first group of LED devices may be the same group of LED devices as the second group, and may span one or more arrays of LED devices, or may be a different group of LED devices from the second group, but the different group of LED devices may include a subset of one or more LED devices from the second group.

The cooling subsystem 2818 may be implemented to manage the thermal behavior of the lighting device 2800, including managing the thermal behavior of one or more components of the power source 2816, control system 2814, and light-emitting subsystem 2812. For example, the cooling subsystem 2818 may provide for cooling of light-emitting subsystem 2812, and more specifically, electronic components thereof such as the semiconductor devices 2819. As other examples, the cooling subsystem 2818 may provide for cooling of electronic components such as CPU processors, transistors (e.g., MOSFET), power sources, and the like, of lighting device 2800. Furthermore, the cooling subsystem 2818 may also be implemented to cool the workpiece 2826 and/or the space between the workpiece 2826 and the lighting device 2800 (e.g., the light-emitting subsystem 2812). For example, cooling subsystem 2818 may comprise an air or other fluid (e.g., water) cooling system. Cooling subsystem 2818 may also include cooling elements such as cooling fins and/or heat sinks conductively coupled and/or attached to the semiconductor devices 2819, or linear array 2820 thereof, or to the coupling optics 2830. For example, cooling subsystem may include an array of cooling fans for blowing cooling air over the coupling optics 2830, wherein the coupling optics 2830 are equipped with external fins to enhance heat transfer. Additionally or alternatively, as further described herein, the cooling subsystem 2818 may include an array of cooling fans for discharging air flow on to or over heat sinks conductively coupled to the radiation-emitting elements.

The lighting device 2800 may be used for various applications. Examples include, without limitation, curing applications ranging from displays, photoactive adhesives, and ink printing to the fabrication of DVDs and lithography. The applications in which the lighting device 2800 may be employed can have associated operating parameters. That is, an application may have associated operating parameters as follows: provision of one or more levels of radiant power, at one or more wavelengths, applied over one or more periods of time. In order to properly accomplish the photoreaction associated with the application, optical power may be delivered at or near the workpiece 2826 at or above one or more predetermined levels of one or a plurality of these parameters (and/or for a certain time, times or range of times).

In order to follow an intended application's parameters, the semiconductor devices 2819 providing radiant output 2824 may be operated in accordance with various characteristics associated with the application's parameters, e.g., temperature, spectral distribution and radiant power. At the same time, the semiconductor devices 2819 may have certain operating specifications, which may be associated with the semiconductor devices' fabrication and, among other things, may be followed in order to preclude destruction and/or forestall degradation of the devices. Other components of the lighting device 2800 may also have associated operating specifications. These specifications may include ranges (e.g., maximum and minimum) for operating temperatures and applied electrical power, among other parameter specifications.

Accordingly, the lighting device 2800 may support monitoring of the application's parameters. In addition, the lighting device 2800 may provide for monitoring of semiconductor devices 2819, including their respective characteristics and specifications. Moreover, the lighting device 2800 may also provide for monitoring of selected other components of the lighting device 2800, including its characteristics and specifications.

Providing such monitoring may enable verification of the system's proper operation so that operation of lighting device 2800 may be reliably evaluated. For example, lighting device 2800 may be operating improperly with respect to one or more of the application's parameters (e.g. temperature, spectral distribution, radiant power, and the like), any component's characteristics associated with such parameters and/or any component's respective operating specifications. The provision of monitoring may be responsive and carried out in accordance with the data received by the control system 2814 from one or more of the system's components.

Monitoring may also support control of the system's operation. For example, a control strategy may be implemented via the control system 2814, the control system 2814 receiving and being responsive to data from one or more system components. This control strategy, as described above, may be implemented directly (e.g., by controlling a component through control signals directed to the component, based on data respecting that components operation) or indirectly (e.g., by controlling a component's operation through control signals directed to adjust operation of other components). As an example, a semiconductor device's radiant output may be adjusted indirectly through control signals directed to the power source 2816 that adjust power applied to the light-emitting subsystem 2812 and/or through control signals directed to the cooling subsystem 2818 that adjust cooling applied to the light-emitting subsystem 2812.

Control strategies may be employed to enable and/or enhance the system's proper operation and/or performance of the application. In one example, the irradiance at one or more locations at the workpiece 2826 surface may be detected by sensors and transmitted to control system 2814 in a feedback control scheme.

In some applications, high radiant power may be delivered to the workpiece 2826. Accordingly, the light-emitting subsystem 2812 may be implemented using an array of light-emitting semiconductor devices 2820. For example, the light-emitting subsystem 2812 may be implemented using a high-density, light-emitting diode (LED) array. Although linear array of light-emitting elements may be used and are described in detail herein, it is understood that the semiconductor devices 2819, and linear arrays 2820 thereof, may be implemented using other light-emitting technologies without departing from the principles of the invention; examples of other light-emitting technologies include, without limitation, organic LEDs, laser diodes, other semiconductor lasers.

Continuing with FIG. 28, the plurality of semiconductor devices 2819 may be provided in the form of one or more arrays 2820, or an array of arrays, as shown in FIG. 28. The arrays 2820 may be implemented so that one or more, or most of the semiconductor devices 2819 are configured to provide radiant output. At the same time, however, one or more of the array's semiconductor devices 2819 may be implemented so as to provide for monitoring selected of the array's characteristics. One or more monitoring devices 2836 may be selected from among the devices in the array and, for example, may have the same structure as the other, emitting devices. For example, the difference between emitting and monitoring may be determined by the coupling electronics 2822 associated with the particular semiconductor device (e.g., in a basic form, an LED array may have monitoring LED devices where the coupling electronics provides a reverse current, and emitting LED devices where the coupling electronics provides a forward current).

Furthermore, based on coupling electronics, selected of the semiconductor devices in the array may be either/both multifunction devices and/or multimode devices, where (a) multifunction devices may be capable of detecting more than one characteristic (e.g., either radiant output, temperature, magnetic fields, vibration, pressure, acceleration, and other mechanical forces or deformations) and may be switched among these detection functions in accordance with the application parameters or other determinative factors and (b) multimode devices may be capable of emission, detection and some other mode (e.g., off) and may be switched among modes in accordance with the application parameters or other determinative factors.

Note that the example control and estimation routines included herein can be used with various lighting sources and lighting system configurations. The control methods and routines disclosed herein may be stored as executable instructions on-board a controller in non-transitory memory. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to various Lambertian or near-Lambertian light sources. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A photocurable composition, comprising:
a photoinitiator mixture, consisting only of a mixture of biocompatible compounds, including one or more of naproxen, caffeine, uracil, quercetin, and cyanocobalamin,
and a polymer resin.

2. The photocurable composition of claim 1, wherein the mixture of biocompatible compounds consists of FDA generally recognized as safe (GRAS) substances and FDA over-the-counter (OTC) compounds.

3. The photocurable composition of claim 1, wherein the photoinitiator mixture further includes riboflavin.

4. The photocurable composition of claim 1, wherein the photoinitiator mixture includes an electron donor.

5. The photocurable composition of claim 1, wherein the electron donor includes L-arginine.

6. The photocurable composition of claim 1, wherein the photocurable composition includes a food-safe emulsifier.

7. The photocurable composition of claim 1, wherein the food-safe emulsifier includes one or more of sodium stearoyl lactate, L-a-phosphatidyl choline, and 2-hydroxyethyl cellulose.

8. The photocurable composition of claim 1, not comprising benzophenone, thioxanthone, onium salt, nitrile, azo, benzylketal, benzoin, hydroxyacetophenone, phosphine oxide, and alpha-aminoalkylacetophenone.

9. The photocurable composition of claim 1, further comprising a pigment.

10. A method of preparing a photocurable composition, comprising:
preparing a photoinitiator mixture, wherein the photoinitiator mixture consists only of biocompatible compounds, the biocompatible compounds including,
a photoinitiator, the photoinitiator including one or more of naproxen, aspirin, caffeine, uracil, quercetin, and cyanocobalamin, and
mixing the photoinitiator mixture with a polymer resin.

11. The method of claim 10, wherein the biocompatible compounds includes a biocompatible emulsifier, and preparing the photoinitiator mixture includes mixing the photoinitiator with a biocompatible emulsifier.

12. The method of claim 10, wherein mixing the photoinitiator with the biocompatible emulsifier includes mixing the photoinitiator with the biocompatible emulsifier or mixing the polymer resin with the biocompatible emulsifier prior to mixing the photoinitiator mixture with the polymer resin.

13. The method of claim 10, wherein preparing the biocompatible initiator mixture includes mixing a photoinitiator with an emulsifier after adding the photoinitiator and the emulsifier to the biocompatible initiator mixture.

14. The method of claim 10, wherein the photoinitiator consists of a solid powder, and mixing the photoinitiator with the polymer resin includes mixing the solid powder with the polymer resin.

15. The method of claim 10, wherein the photoinitiator consists of an aqueous solution, and mixing the photoinitiator with the polymer resin includes mixing the aqueous solution with the polymer resin.

16. A method of curing a photocurable composition, including:
preparing the photocurable composition, including preparing a photoinitiator mixture, wherein the photoinitiator mixture consists only of biocompatible compounds, the biocompatible compounds including,
a photoinitiator, the photoinitiator including one or more of naproxen, aspirin, caffeine, uracil, quercetin, and cyanocobalamin, and
mixing the photoinitiator mixture with a polymer resin,
and irradiating the photocurable composition with UV radiation at wavelengths other than 395 nm.

17. The method of claim 1, wherein irradiating the photocurable composition with UV radiation consists of irradiating the photocurable composition with 278 nm wavelength UV radiation.

18. The method of claim 1, wherein irradiating the photocurable composition with UV radiation consists of irradiating the photocurable composition with 365 nm wavelength UV radiation.

19. The method of claim 1, wherein irradiating the photocurable composition with UV radiation consists of irradiating the photocurable composition with 278 nm and 365 nm wavelength UV radiation.

20. The method of claim 19, wherein irradiating the photocurable composition with UV radiation includes irradiating the photocurable composition with the 278 nm, prior to irradiating the photocurable composition with the 365 nm wavelength UV radiation.
